(19) United States
(12) Patent Application Publication
(10) Pub. No.: US 2022/0094485 A1
(43) Pub. Date: Mar. 24, 2022

(54) TERMINAL APPARATUS, BASE STATION APPARATUS, AND COMMUNICATION METHOD

(71) Applicants: SHARP KABUSHIKI KAISHA, Sakai City, Osaka (JP); FG Innovation Company Limited, New Territories, Hong Kong (CN)

(72) Inventors: HUIFA LIN, Sakai City, Osaka (JP); SHOICHI SUZUKI, Sakai City, Osaka (JP); TOSHIZO NOGAMI, Sakai City, Osaka (JP); TOMOKI YOSHIMURA, Sakai City, Osaka (JP); DAIICHIRO NAKASHIMA, Sakai City, Osaka (JP)

(21) Appl. No.: 17/424,837

(22) PCT Filed: Mar. 5, 2020
(86) PCT No.: PCT/JP2020/009430

§ 371 Date: Jul. 21, 2021

(30) Foreign Application Priority Data
Mar. 29, 2019 (JP) 2019-066465

(51) Int. Cl. H04L 1/18

(52) U.S. Cl. CPC H04L 1/1887

(57) ABSTRACT

It is possible to efficiently perform uplink transmission, A terminal apparatus is configured to receive a PDCCH and to transmit one or multiple first PUSCHs scheduled based at least on a DCI format included in the PDCCH, A size of an HARQ-ACK codebook to be mapped to any of one or multiple second PUSCHs included in the one or multiple first PUSCHs is provided based at least on a UL DAI included in the DCI format. The one or multiple second PUSCHs are provided based at least on some or all of a selection method 1, a selection method 2, a selection method 3, a selection method 4, a selection method 5, a selection method 6, a selection method 7, and a selection method S. A method for indicating the selected PUSCH is any of an indication method 1, an indication method 2, an indication method 3, and an indication method 4.

### TECHNICAL FIELD

The present invention relates to a terminal apparatus, a base station apparatus, and a communication method. This application claims priority based on Japanese Patent Application No. 2019-66465 tiled on Mar. 29, 2019, the contents of which are incorporated herein by reference.

### BACKGROUND ART

In the 3^{rd} Generation Partnership Project (3GPP), a radio access method and a radio network for cellular mobile communications (hereinafter referred to as “Long Term Evolution (LTE)” or “Evolved Universal Terrestrial Radio Access (EUTRA)”) have been studied. In LTE, a base station apparatus is also referred to as an evolved NodeB (eNodeB), and a terminal apparatus is also referred to as User Equipment (UE). LTE is a cellular communication system in which multiple areas covered by a base station apparatus are distributed in a cell structure. A single base station apparatus may manage multiple serving cells.

3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is required to satisfy requirements for three use cases including enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, 7th to 10 Mar. 2016.

### SUMMARY OF INVENTION

### Technical Problem

One aspect of the present invention provides a terminal apparatus that efficiently performs communication, a communication method used for the terminal apparatus, a base station apparatus that efficiently performs communication, and a communication method used for the base station apparatus.

### Solution to Problem

(1) A first aspect of the present invention provides a terminal apparatus configured to receive a PDCCH and to transmit one or multiple first PUSCHs scheduled based at least on a DCI format included in the PDCCH, wherein a size of an HARQ-ACK codebook to be mapped to any of one or multiple second PUSCHs included in the one or multiple first PUSCHs is provided based at least on a UL DAI included in the DCI format, the one or multiple second PUSCHs are provided based at least on some or all of a selection method 1, a selection method 2, a selection method 3, a selection method 4, a selection method 5, a selection method 6, a selection method 7, and a selection method 8, the selection method 1 is a method for selecting a starting PUSCH, the selection method 2 is a method for selecting a PUSCH immediately subsequent to the starting PUSCH, the selection method 3 is a method for selecting a PUSCH with a preconfigured index, the selection method 4 is a selection method for aperiodic CSI, the selection method 5 is a method for selecting an ending PUSCH, the selection method 6 is a method for selecting a PUSCH immediately preceding the ending PUSCH, the selection method 7 is a method for selecting a PUSCH indicating transmission of the HARQ-ACK codebook, the selection method 8 is a method for selecting multiple PUSCHs, a method for indicating the selected PUSCH is any of an indication method 1, an indication method 2, an indication method 3, and an indication method 4, the indication method 1 is a method for indication by the DCI format, the indication method 2 is a method for indication by a MAC CE, the indication method 3 is a method for indication by RRC signaling, and the indication method 4 is a method for indication for the aperiodic CSI.

(2) A second aspect of the present invention provides a base station apparatus configured to transmit a PDCCH and to receive one or multiple first PUSCHs scheduled based at least on a DCI format included in the PDCCH, wherein a size of an HARQ-ACK codebook to be mapped to any of one or multiple second PUSCHs included in the one or multiple first PUSCHs is provided based at least on a UL DAI included in the DCI format, the one or multiple second PUSCHs are provided based at least on some or all of a selection method 1, a selection method 2, a selection method 3, a selection method 4, a selection method 5, a selection method 6, a selection method 7, and a selection method 8, the selection method 1 is a method for selecting a starting PUSCH, the selection method 2 is a method for selecting a PUSCH immediately subsequent to the starting PUSCH, the selection method 3 is a method for selecting a PUSCH with a preconfigured index, the selection method 4 is a selection method for aperiodic CSI, the selection method 5 is a method for selecting an ending PUSCH, the selection method 6 is a method for selecting a PUSCH immediately preceding the ending PUSCH, the selection method 7 is a method for selecting a PUSCH indicating transmission of the HARQ-SCK codebook, the selection method 8 is a method for selecting multiple PUSCHs, a method for indicating the selected PUSCH is any of an indication method 1, an indication method 2, an indication method 3, and an indication method 4, the indication method 1 is a method for indication by the DCI format, the indication method 2 is a method for indication by a MAC CE, the indication method 3 is a method for indication by RRC signaling, and the indication method 4 is a method for indication for the aperiodic CSI.

(3) A third aspect of the present invention is a communication method used for a terminal apparatus, the communication method including the steps of receiving a PDCCH and transmitting one or multiple first PUSCHs scheduled based at least on a DCI format included in the PDCCH, wherein a size of an HARQ-ACK codebook to be mapped to any of one or multiple second PUSCHs included in the one or multiple first PUSCHs is provided based at least on a UL DAI included in the DCI format, the one or multiple second PUSCHs are provided based at least on some or all of a selection method 1, a selection method 2, a selection method 3, a selection method 4, a selection method 5, a selection method 6, a selection method 7, and a selection method 8, the selection method 1 is a method for selecting a starting PUSCH, the selection method 2 is a method for selecting a PUSCH immediately subsequent to the starting PUSCH, the selection method 3 is a method for selecting a PUSCH with a preconfigured index, the selection method 4 is a selection method for aperiodic CSI, the selection method 5 is a method for selecting an ending PUSCH, the selection method 6 is a method for selecting a PUSCH immediately preceding the ending PUSCH, the selection method 7 is a method for selecting a PUSCH indicating transmission of the HARQ-ACK codebook, the selection method 8 is a method for selecting multiple PUSCHs, a method for indicating the selected PUSCH is any of an indication method l , an indication method 2, an indication method 3, and an indication method 4, the indication method 1 is a method for indication by the DCI format, the indication method 2 is a method for indication by a MAC CE, the indication method 3 is a method for indication by RRC signaling, and the indication method 4 is a method for indication for the aperiodic CSI,

(4) A fourth aspect of the present invention is a communication method used for a base station apparatus, the communication method including the steps of transmitting a PDCCH and receiving one or multiple first PUSCHs scheduled based at least on a Del format included in the PDCCH, wherein a size of an HARQ-ACK codebook to be mapped to any of one or multiple second PUSCHs included in the one or multiple first PUSCHs is provided based at least on a UL DAI included in the Do format, the one or multiple second PUSCHs are provided based at least on some or all of a selection method 1, a selection method 2, a selection method 3, a selection method 4, a selection method 5, a selection method 6, a selection method 7, and a selection method 8, the selection method I is a method for selecting a starting PUSCH, the selection method 2 is a method for selecting a PUSCH immediately subsequent to the starting PUSCH, the selection method 3 is a method for selecting a PUSCH with a preconfigured index, the selection method 4 is a selection method for aperiodic CSI, the selection method 5 is a method for selecting an ending PUSCH, the selection method 6 is a method for selecting a PUSCH immediately preceding the ending PUSCH, the selection method 7 is a method for selecting a PUSCH indicating transmission of the HARQ-ACK codebook, the selection method 8 is a method for selecting multiple PUSCHs, a method for indicating the selected PUSCH is any of an indication method 1, an indication method 2, an indication method 3, and an indication method 4, the indication method I is a method for indication by the DCI format, the indication method 2 is a method for indication by a MAC CE, the indication method 3 is a method for indication by RRC signaling, and the indication method 4 is a method for indication for the aperiodic CSI.

### Advantageous Effects of Invention

According to one aspect of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship of N^{slot}_{symb}, a subcarrier spacing configuration μ, a slot configuration, and a CP configuration according to an aspect of the present embodiment.

FIG. 3 is a schematic diagram illustrating an example of a resource grid in a subframe according to an aspect of the present embodiment.

FIG. 4 is a diagram illustrating an example of monitoring occasions for search space sets according to an aspect of the present embodiment.

FIG. 5 is a schematic block diagram illustrating a configuration of a terminal apparatus 1 according to an aspect of the present embodiment.

FIG. 6 is a schematic block diagram illustrating a configuration of a base station apparatus 3 according to an aspect of the present embodiment.

FIG. 7 is a diagram illustrating an example of correspondence between monitoring occasions for a search space set and monitoring occasions for a PDCCH according to an aspect of the present embodiment.

FIG. 8 is a diagram illustrating an example of a procedure of configuration of a codebook HARQ-ACK information (HARQ-ACK codebook) according to an aspect of the present embodiment.

FIG. 9 is a diagram illustrating an example of the procedure of configuration of the codebook of HARQ-ACK information (HARQ-ACK codebook) according to an aspect of the present embodiment.

FIG. 10 is a diagram illustrating an example of the procedure of configuration of the codebook of HARQ-ACK information (HARQ-ACK codebook) according to an aspect of the present embodiment.

FIG. 11 is a diagram illustrating functions of UL DAI according to an aspect of the present embodiment.

FIG. 12 is a diagram illustrating a method for selecting an PUSCH to which an UL DAI is applied according to an aspect of the present embodiment.

### DESCRIPTION OF EMBODIMENTS

Embodiments of the present invention will be described below.

“A and/or B” may be a term including “A B,”, or “A and B.”

The fact that a parameter or information indicates one or multiple values may mean that the parameter or the information includes at least a parameter or information indicating the one or the multiple values. A higher layer parameter may be a single higher layer parameter. The higher layer parameter may be an Information Element (IE) including multiple parameters.

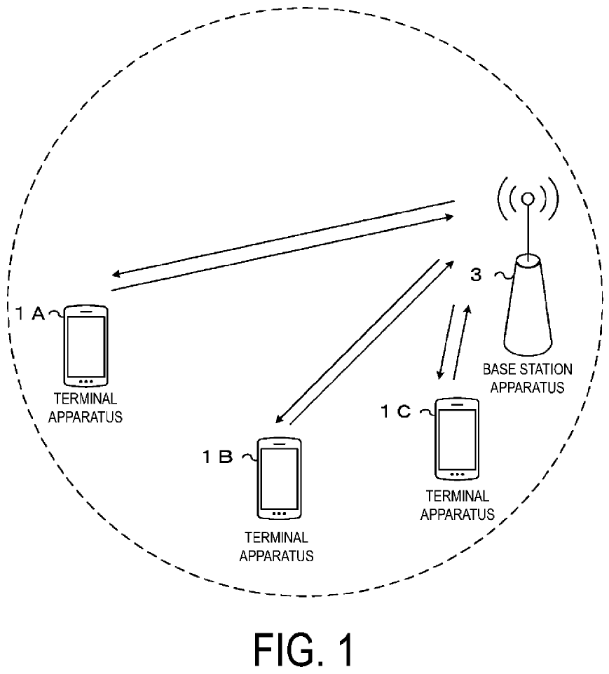

FIG. 1 is a conceptual diagram of a radio communication system according to an aspect of the present embodiment. In FIG. 1, the radio communication system includes terminal apparatuses 1A to 1C and a base station apparatus 3. Hereinafter, each of the terminal apparatuses 1A to 1C is also referred to as a terminal apparatus 1.

The base station apparatus 3 may be configured to include one of or both a Master Cell Group (MCG) and a Secondary Cell Group (SCG). The MCG is a group of serving cells configured to include at least a Primary Cell (PCell). The SCG is a group of serving cells configured to include at least a Primary Secondary Cell (PSCell). The PCell may be a serving cell provided based on an initial connection. The MCG may include one or multiple Secondary Cells (SCells). The SCG may include one or multiple SCells. A serving cell identity is a short identity for identifying the serving cell. The serving cell identity may be provided by a higher layer parameter.

Hereinafter, a frame structure will be described.

In the radio communication system according to an aspect of the present embodiment, at least Orthogonal Frequency Division Multiplex (OFDM) is used. The OFDM symbol is a unit of a time domain of the OFDM. The OFDM symbol includes at least one or multiple subcarriers. The OFDM symbol may be converted into a time-continuous signal in baseband signal generation.

A SubCarrier Spacing (SCS) may be provided as a subcarrier spacing Δf=2^{μ}8 15 kHz. For example, a subcarrier spacing configuration μ may be configured to be ally of 0, 1, 2, 3, 4, and/or 5. For a certain BandWidth Part (BWP), the subcarrier spacing configuration may be provided by a higher layer parameter.

In the radio communication system according to an aspect of the present embodiment, a time unit T_{c} is used for representing a length of the time domain. The time unit T_{c} may be provided as T_{c}=1/(Δfₘₐₓ*N_{f}). Δfₘₐₓ may be the maximum value of the subcarrier spacing supported by the radio communication system according to an aspect of the present embodiment. Δfₘₐₓ may satisfy Δfₘₐₓ=480 kHz. N_{f} may satisfy N_{f}=4096. A constant κ satisfies κ=Δfₘₐₓ* N_{f}/(Δf_{ref}N_{f,ref})=64. Δf_{ref} may be 15 kHz. N_{f,ref} may be 2048.

The constant κ may be a value indicating a relationship between a reference subcarrier spacing and T_{c}. The constant K may be used for a length of a subframe. The number of slots included in the subframe may be provided based at least on the constant κ. Δf_{ref} is the reference subcarrier spacing, and N_{f,ref} is a value corresponding to the reference subcarrier spacing.

Downlink transmission and/or uplink transmission includes frames of 10 ms. frame is configured to include 10 subframes. A length of a subframe is 1 ms. The length of the frame may provided regardless of the subcarrier spacing Δf. In other words, the frame configuration may be provided regardless of μ. The length of the subframe may be provided regardless of the subcarrier spacing Δf. In other words, the configuration of the subframe may be provided regardless of μ.

For a certain subcarrier spacing configuration u, the number and indexes of slots included in a subframe may be provided. For example, a first slot number eₛ may be provided in ascending order ranging from 0 to N^{subframe,μ}ₛₗₒₜ−1 within a subframe. For the subcarrier spacing configuration μ, the number and indexes of slots included in a frame may be provided. For example, a second slot number n^{μ}_{s,f} may be provided in ascending order ranging from 0 to N^{frame,μ}ₛₗₒₜ−1within a frame. N^{slot}_{symb} continuous OFDM symbols may be included in one slot N^{slot}_{symb} may be provided based at least on a part or an entirety of a slot configuration and/or a Cyclic Prefix (CP) configuration. The slot configuration may be provided at least by a higher layer parameter tdd-UL-DL-ConfigurationCommon. The CP configuration may be provided based at least on a higher layer parameter. The CP configuration may be provided based at least on dedicated RRC signaling. Each of the first slot number and the second slot number is also referred to as slot number (slot index).

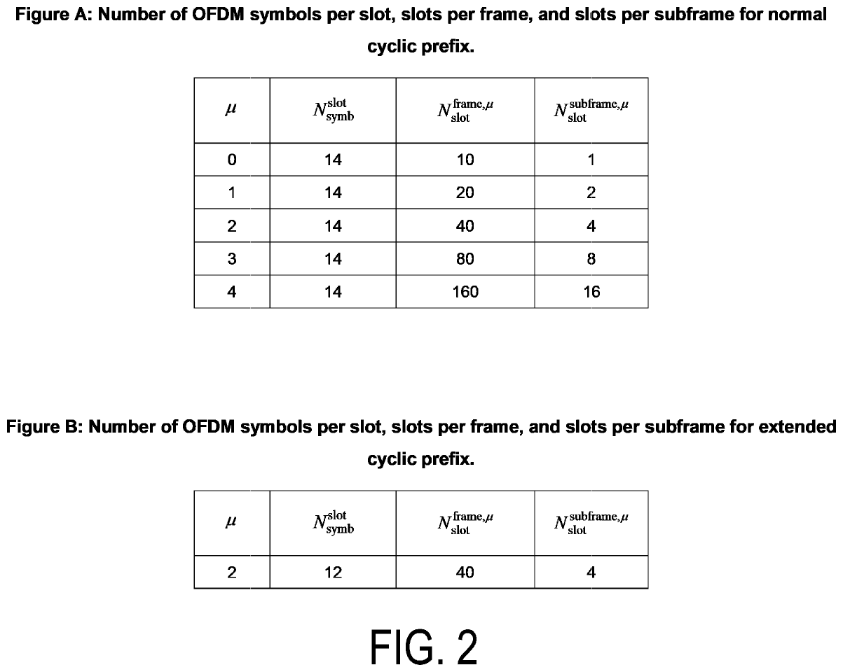

FIG. 2 is an example illustrating a relationship of N^{slot}_{symb}, a subcarrier spacing configuration μ, and a CP configuration according to an aspect of the present embodiment. In FIG. 2A, for example, in a case that the subcarrier spacing configuration μ is two and the CP configuration is a normal cyclic prefix (normal CP), N^{slot}_{symb}=14, N^{frame,μ}ₛₗₒₜ=40, and N^{subframe μ}ₛₗₒₜ =4. In addition, in FIG. 2B, for example, in a case that the subcarrier spacing configuration μ is two and the CP configuration is an extended cyclic prefix (extended CP), N^{slot}_{symb}=12, N^{frame,μ}ₛₗₒₜ=40, and N^{subframe,μ}ₛₗₒₜ=4.

Physical resources will be described below.

An antenna port is defined in such a manner that a channel through which a symbol is transmitted at one antenna port can be estimated from a channel through Which another symbol is transmitted at the same antenna port. In a case that a large scale property of a channel through which a symbol is transmitted at one antenna port can be estimated from a channel through which a symbol is transmitted at another antenna port, the two antenna ports are referred to as Quasi Co-Located (QCL). The large scale properties may include at least a long term performance of a channel. The large scale properties may include at least some or all of delay spread, Doppler spread, Doppler shift, an average gain, an average delay, and beam parameters (spatial Rx parameters). The fact that a first antenna port and a second antenna port are QCL with respect to a beam parameter may mean that a reception beam assumed by the reception side for the first antenna port is the same as a reception beam assumed by the reception side for the second antenna port. The fact that the first antenna port and the second antenna port are QCL with respect to a beam parameter may mean that a transmission beam assumed by the reception side for the first antenna port is the same as a transmission beam assumed by the reception side for the second antenna port. In a case that a large scale property of a channel through which a symbol is transmitted at one antenna port can be estimated from a channel through which a symbol is transmitted at another antenna port, the two antenna ports may be assumed to be QCL in the terminal apparatus 1. The fact that the two antenna ports are QCL may mean that the two antenna ports are assumed to be QCL.

For each set of a subcarrier spacing configuration and a carrier, a resource grid including ^{μ}_{RB,x}N^{RB}_{sc} subcarriers and N^{(μ)}_{symb}N^{subframe,μ}_{symb} OFDM symbols is provided. N^{μ}_{RB,x} may indicate the number of resource blocks provided for the subcarrier spacing configuration μ for a carrier x. N^{μ}_{RB,x} may indicate the maximum number of resource blocks provided for the subcarrier spacing configuration μ for the carrier x. The carrier x indicates either a downlink carrier or an uplink carrier. In other words, x is “DL” or “UL”. N^{μ}_{RB} a name including N^{μ}_{RB,DL} and/or N^{μ}_{RB,UL}. N^{RB}_{sc} may indicate the number of subcarriers included in one resource block. At least one resource grid may be provided for each antenna port p and/or for each subcarrier spacing configuration μ and/or for each Transmission direction configuration. The transmission direction includes at least Downlink (DL) and UpLink (UL). Hereinafter, a set of parameters including at least some or all of the antenna port p, the subcarrier spacing configuration μ, and the transmission direction configuration is also referred to as a first radio parameter set. In other words, one resource grid may be provided for each first radio parameter set.

A carrier included in a serving cell in downlink is referred to as a downlink carrier (or a downlink component carrier). A carrier included in a serving cell in uplink is referred to as an uplink carrier (uplink component carrier). A downlink component carrier and an uplink component carrier are collectively referred to as a component carrier (or a carrier).

Each element in the resource grid provided for each first radio parameter set is referred to as a resource element. The resource element is identified by an index k_{sc} of the frequency domain and an index l_{symb} of the time domain. The resource element is identified by an index k_{sc} of the frequency domain and an index l_{symb} of the time domain for a certain first radio parameter set. The resource element to be identified by the index k_{sc} of the frequency domain and the index l_{symb} of the time domain is also referred to as a resource element (k_{sc}, l_{symb}). The index k_{sc} of the frequency domain indicates any value from 0 to N^{μ}_{RB}N^{RB}_{sc}−1. N^{μ}_{RB} may be the number of resource blocks provided for the subcarrier spacing configuration μ. N^{RB}_{sc} is the number of subcarriers included in a resource block, and N^{RB}_{sc}=12. The index k_{sc} of the frequency domain may correspond to a subcarrier index k_{sc}. The index l_{sym} of the time domain may correspond to an OFDM symbol index l_{sym}.

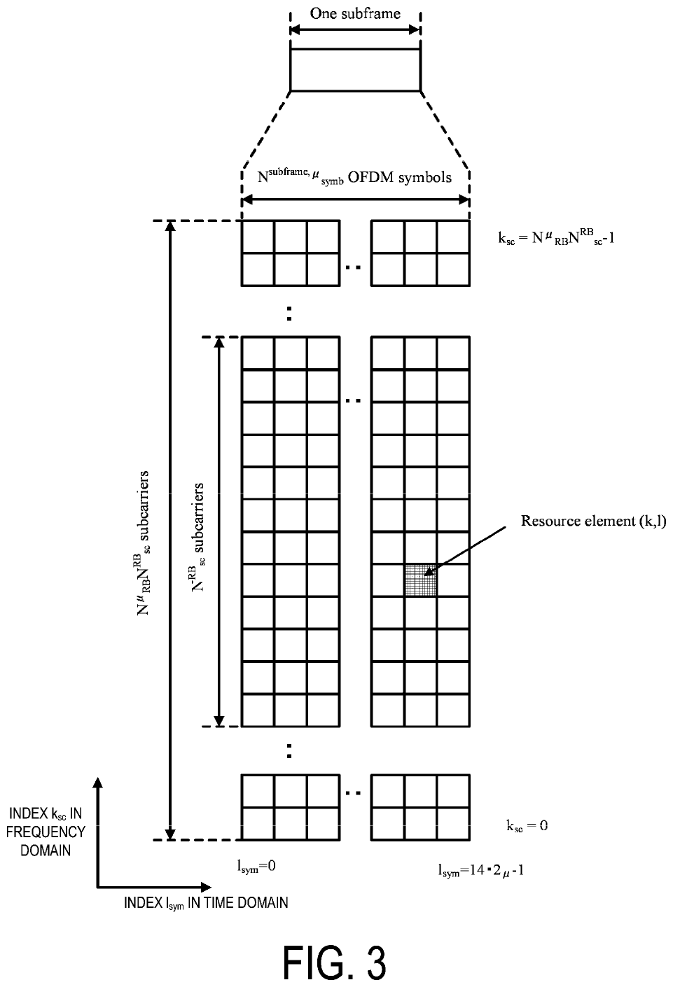

FIG. 3 is a schematic diagram illustrating an example of a resource grid in a subframe according to an aspect of the present embodiment. In the resource grid in FIG. 3, the horizontal axis is the index l_{sym} of the time domain, and the vertical axis is the index k_{sc} of the frequency domain, In one subframe, the frequency domain of the resource grid includes N^{μ}_{RB}N^{RB}_{sc} subcarriers. In one subframe, the time domain of the resource grid may include 14*2^{μ}OFDM symbols. One resource block is configured to include N^{RB}_{sb} subcarriers. The time domain of the resource block may correspond to one OFDM symbol. The time domain of the resource block may correspond to 14 OFDM symbols. The time domain of the resource block may correspond to one or multiple slots. The time domain of the resource block may correspond to one subframe.

The terminal apparatus 1 may receive an indication of transmission and/or reception using only a subset of resource grids. The subset of resource grids is also referred to as a BWP, and the BWP may be provided based at least on a part or an entirety of the higher layer parameter and/or DCI. The BWP is also referred to as a bandwidth part (BP). In other words, the terminal apparatus 1 may not receive an indication of transmission and/or reception using all sets of resource grids. In other words, the terminal apparatus 1 may receive an indication of transmission and/or reception using some frequency resources within the resource grid. One MVP may include multiple resource blocks in the frequency domain. One BWP may include multiple resource blocks that are continuous in the frequency domain. A BWP configured for a downlink carrier is also referred to as a downlink BWP. A BWP configured for an uplink carrier is also referred to as an uplink BWP.

One or multiple downlink BWPs may be configured for the terminal apparatus 1. The terminal apparatus 1 may attempt to receive a physical channel (for example, a PDCCH, a PDSCH, and/or an SS/PBCH) in one downlink BWP out of the one or multiple downlink BWPs. The one downlink BWP is also referred to as an active downlink BWP.

One or multiple uplink BWPs may be configured for the terminal apparatus 1. The terminal apparatus 1 may attempt to transmit a physical channel (for example, a PDCCH, a PUSCH, and/or a PRACH) in one uplink BWP out of the one or multiple uplink BWPs. The one uplink BWP is also referred to as an active uplink BWP.

A set of downlink BWPs may be configured for each serving cell. The set of downlink BWPs may include one or multiple downlink BWPs. A set of uplink BWPs may be configured for each serving cell. The set of uplink BWPs may include one or multiple uplink BWPs.

A higher layer parameter is a parameter included in a higher layer signaling. The higher layer signaling may be Radio Resource Control (RRC) signaling or a Medium Access Control Control Element (MAC CE). Here, the higher layer signaling may be an RRC layer signal or a MAC layer signal.

The higher layer signaling may be common RRC signaling. The common RRC signaling may include at least some or all of the following features C1 to C3.

Feature C1) the common RRC signaling is mapped to a BCCH logical channel or a CCCH logical channel.

Feature C2) the common RRC signaling includes at least a radioResourceConfigCommon information element.

Feature C3) the common RRC signaling is mapped to the PBCH.

The radioResourceConfigCommon information element may include information indicating a configuration commonly used in a serving cell. The configuration commonly used in a serving cell may include at least a PRACH configuration. The PRACH configuration may indicate at least one or multiple random access preamble indexes. The PRACH configuration may indicate at least a time/frequency resource of the PRACH.

The higher layer signaling may be dedicated RRC signaling, The dedicated RRC signaling may include at least some or all of the following features D1 and D2.

Feature D1) to be mapped to a DCCH logical channel, or Feature D2) to include at least a radioResourceConfigDedicated information element.

The radioResourceConfigDedicated information element may include at least information indicating a configuration specific to the terminal apparatus 1. The radioResourceConfigDedicated information element may include at least information indicating a BWP configuration. The BWP configuration may indicate at least a frequency resource of the BWP.

For example, a MIB, first system information, and second system information may be included in the common RRC signaling. In addition, a higher layer message that is mapped to the DCCH logical channel and includes at least radioResourceConfigCommon may be included in the common RRC signaling. In addition, a higher layer message that is mapped to the DCCH logical channel and does not include the radioResourceConfigCommon information element may be included in the dedicated RRC signaling. In addition, a higher layer message that is mapped to the DCCH logical channel and includes at least the radioResourceConfigDedicated information element may be included in the dedicated RRC signaling.

The first system information may indicate at least a time index of a Synchronization Signal (SS) block. The SS block is also referred to as an SS/PBCH block. The SS/PBCH block is also referred to as an SS/PBCH. The first system information may include at least information related to a PRACH resource. The first system information may include at least information related to a configuration of initial connection. The second system information may be system information other than the first system information.

The radioResourceConfigDedicated information element may include at least information related to a PRACH resource. The radioResourceConfigDedicated information element may include at least information related to the configuration of initial connection.

A physical channel and physical signal according to various aspects of the present embodiment will be described below.

An uplink physical channel may correspond to a set of resource elements that convey information generated in a higher layer. The uplink physical channel is a physical channel used in uplink carrier. In the radio communication system according to an aspect of the present embodiment, at least some or all of the uplink physical channels described below are used.
Physical Uplink Control CHannel (PUCCH)
Physical Uplink Shared CHannel (PUSCH)
Physical Random Access CHannel (PRACH)

The PUCCH may be used to transmit Uplink Control Information (UCI). The uplink control information includes some or all of Channel State Information (CSI), a Scheduling Request (SR), and a Hybrid Automatic Repeat request ACKnowledgement (HARQ-ACK) corresponding to a transport block (TB, a Medium Access Control Protocol Data. Unit (MAC PDU), Downlink-Shared Channel (DL-SCH), and/or a Physical Downlink Shared Channel (PDSCH)).

The HARQ-ACK may include at least an HARQ-ACK bit corresponding at least to one transport block. The HARQ-ACK bit may indicate an acknowledgement (ACK) or a negative-acknowledgement (NACK) corresponding to one or multiple transport blocks. The HARQ-ACK may include at least an HARQ-ACK codebook including one or multiple HARQ-ACK bits. The fact that the HARQ-ACK bit corresponds to one or multiple transport blocks may mean that the HARQ-ACK bit corresponds to a PDSCH including the one or the multiple transport blocks. The HARQ-ACK bit may indicate an ACK or NACK corresponding to one Code Block Group (CBG) included in the transport block.

The Scheduling Request (SR) may be used at least for requesting a resource of a PUSCH for initial transmission. A scheduling request bit may be used to indicate either a positive SR or a negative SR. The scheduling request bit indicating the positive SR is also referred to as “the positive SR being transmitted”. The positive SR may indicate that a resource of the PUSCH for initial transmission is requested by the terminal apparatus 1. The positive SR may indicate that a scheduling request is triggered by the higher layer. The positive SR may be transmitted in a case that the higher layer indicates transmission of the scheduling request. The scheduling request bit indicating the negative SR is also referred to as “the negative SR being transmitted”. The negative SR may indicate that the resource of the PUSCH for initial transmission is not requested by the terminal apparatus 1. The negative SR may indicate that the scheduling request is not triggered by the higher layer. The negative SR may be transmitted in a case that transmission of a scheduling request is not indicated by the higher layer.

Channel state information may include at least some or all of a Channel Quality Indicator (CQI), a Precoder Matrix Indicator (PMI), and a Rank Indicator (RI). The CQI is an indicator related to channel quality (for example, propagation intensity), and the PMI is an indicator that indicates a precoder. The RI is an indicator indicating a transmission rank (or the number of transmission layers).

The PUCCH supports PUCCH formats (PUCCH formats 0 to 4). The PUCCH formats may be mapped to the PUCCH and may then be transmitted. The PUCCH format may be transmitted through the PUCCH. The fact that the PUCCH format is transmitted may mean that the PUCCH is transmitted.

The PUSCH may be used at least to transmit a transport block ((TB), the MAC PDU, a UL-SCH, and/or the PUSCH). The PUSCH may be used to transmit at least some or all of the transport block, the HARQ-ACK, the channel state information, and the scheduling request. The PUSCH is used at least to transmit a random access message 3.

The PRACH is used at least to transmit a random access preamble (random access message 1). The PRACH may be used at least to indicate some or all of an initial connection establishment procedure, a handover procedure, a connection re-establishment procedure, synchronization for PUSCH transmission (timing adjustment), and a resource request for the PUSCH. The random access preamble may be used to notify the base station apparatus 3 of an index (random access preamble index) provided by a higher layer of the terminal apparatus 1.

In FIG. 1, the following uplink physical signals are used for uplink radio communication. The uplink physical signals may not be used to transmit information output from a higher layer, but is used by a physical layer.
UpLink Demodulation Reference Signal (UL DMRS)
Sounding Reference Signal. (SRS)
UpLink Phase Tracking Reference Signal UL PTRS)

The UL DMRS is associated with transmission of the PUSCH and/or the PUCCH. The UL DMRS is multiplexed to the PUSCH or the PUCCH. The base station apparatus 3 may use the UL DMRS in order to perform channel compensation of the PUSCH or the PUCCH. Hereinafter, transmission of both a PUSCH and a UL DMRS associated with the PUSCH will be simply referred to as transmission of a PUSCH. Hereinafter, transmission of both a PUCCH and a UL DMRS associated with the PUCCH will be simply referred to as transmission of a PUCCH. The UL DMRS associated with the PUSCH is also referred to as a UL DMRS for a PUSCH. The UL DMRS associated with the PUCCH is also referred to as a UL DMRS for a PUCCH.

The SRS may not be associated with transmission of the PUSCH or the PUCCH. The base station apparatus 3 may use the SRS for measuring a channel state. The SRS may be transmitted at the end of a subframe in an uplink slot or at a prescribed number of OFDM symbols from the end.

The UL PTRS may be a reference signal that is used at least for phase tracking. The UL PTRS may be associated with a UL DMRS group including at least an antenna port used for one or multiple UL DMRSs. The fact that the UL PTRS associates with the UL DMRS group may mean that at least the antenna port for the UL PTRS and some or all of the antenna ports included in the UL DMRS group are QCL. The UL DMRS group may be identified based at least on the antenna port of the lowest index for the UL DMRS included in the UL DMRS group. The UL PTRS may be mapped to the antenna port of the smallest index from among one or multiple antenna ports to which one codeword is mapped. The UL PTRS may be mapped to a first layer in a case that one codeword is mapped at least to the first layer and a second layer. The UL PTRS may not be mapped to the second layer. The index of the antenna port to which the UL PTRS is mapped may be provided based at least on the downlink control information.

In FIG. 1, the following downlink physical channels are used for downlink radio communication from the base station apparatus 3 to the terminal apparatus 1. The downlink physical channels are used by the physical layer for transmission of information output from a higher layer.
Physical Broadcast Channel (PBCH)
Physical Downlink Control Channel (PDCCH)
Physical Downlink Shared Channel (PDSCH)

The PBCH is used at least to transmit a Master Information Block ((MIB), and/or a Broadcast Channel(BCH)). The PBCH may be transmitted based on a prescribed transmission interval. The PBCH may be transmitted at an interval of 80 ms. The PBCH may be transmitted at an interval of 160 ms. Contents of information included in the PBCH may be updated at every 80 ms. A part or an entirety of the information included in the PBCH may be updated at every 160 ms. The PBCH may include 288 subcarriers. The PBCH may be configured to include two, three, or four OFDM symbols. The MIB may include information associated with an identity (index) of a synchronization signal. The NUB may include information indicating at least some of a slot number, a subframe number, and/or a radio frame number in which a PBCH is transmitted.

The PDCCH is used at least to transmit Downlink Control information (DCI). The PDCCH may be transmitted with at least the downlink control information included therein. The PDCCH may include the downlink control information. The downlink control information is also referred to as a DCI format. The downlink control information may include at least either a downlink grant or an uplink grant. The DCI format used for scheduling the PDSCH is also referred to as a downlink DCI format. The DCI format used for scheduling the PUSCH is also referred to as an uplink DCI format. The downlink grant is also referred to as downlink assignment or downlink allocation. The uplink DCI format includes at least one of or both a DCI format 0_0 and a DCI format 0_1.

The DCI format 0_0 is configured to include at least some or all of 1A to 1F.
1A) DCI format specification field (Identifier for DCI formats field)
1B) Frequency domain resource assignment field
1C) Time domain resource assignment field
1D) Frequency hopping flag field
1E) Modulation and Coding Scheme field (MCS field)

The DCI format specification field may be used at least to indicate which of one or multiple DCI formats the DCI format including the DCI format specification field corresponds to. The one or multiple DCII formats may be provided based at least on some or all of a DCI format 1_0, a DCI format 1_1, the DCI format 0_0, and/or the DCI format 0_1.

The frequency domain resource assignment field may be used at least to indicate assignment of a frequency resource for the PUSCH scheduled by the DCI format including the frequency domain resource assignment field. The frequency domain resource assignment field is also referred to as Frequency Domain Resource Allocation (FDRA) field.

The time domain resource assignment field may be used at least to indicate assignment of a time resource for the PUSCH scheduled by the DCI format including the time domain resource assignment field.

The frequency hopping flag field may be used at least to indicate whether frequency hopping is to be applied to the PUSCH scheduled by the DCI format including the frequency hopping flag field.

The MCS field may be used at least to indicate some or all of a modulation scheme for the PUSCH scheduled by the DCI format including the MCS field and/or a target coding rate. The target coding rate may be a target coding rate for a transport block of the PUSCH. The size of the transport block (Transport Block Size (TBS)) may be provided based at least on the target coding rate.

The DCI format 0_1 is configured to include at least some or all of 2A to 2G.
2A) DCI format specification field
2B) Frequency domain resource assignment field
2C) Time domain resource assignment field
2D) Frequency hopping flag field
2E) MCS field
2F) CSI request field
2G) BWP field
2H) first UL DAI field (1^{st} downlink assignment index)
2I) Second UL DAI field (2^{nd} downlink assignment index)

The first UL DAI field is at least used to indicate the transmission status of the PDSCH. In a case that a dynamic HARQ-ACK codebook is used, the size of the first UL DAI field may be 2 bits.

The second UL DAI field is at least used to indicate the transmission status of the PDSCH. In a case that a dynamic HARQ-ACK codebook that includes two sub-codebooks is used, the size of the second UL DAI field may be 2 bits.

The BWP field may be used to indicate the uplink BWP to which the PDSCH scheduled by the DO format 0_1 is mapped.

The CSI request field is used at least to indicate a report of the CSI. The size of the CSI request field may be provided based at least on a higher layer parameter ReportTriggerSize.

The downlink DCI format includes at least one of or both the DCI format 1_0 and the DCI format 1_1.

The DCI format 1_0 is configured to include at least some or all of 3A to 3H.
3A) DO format specification field (Identifier for DCI formats field)
3B) Frequency domain resource assignment field
3C) Time domain resource assignment field
3D) Frequency hopping flag field
3E) Modulation and Coding Scheme field (MCS field)
3F) First CSI request field
3G) PDSCH-to-HARQ feedback timing indicator field
3H) PUCCH resource indicator field

The timing indicator field from the PDSCH to the HARQ feedback may be a field indicating a timing K1. In a case that the index of the slot including the last OFDM symbol of the PDSCH is a slot n, the index of the slot including the PUCCH or the PUSCH including at least HARQ-ACK corresponding to the transport block included in the PDSCH may be n+K1. In a case that the index of the slot including the last OFDM symbol of the PDSCH is a slot n, the index of the slot including the OFDM symbol at the head of the PUCCH or the OFDM symbol at the head of the PDSCH including at least HARQ-ACK corresponding to the transport block included in the PDSCH may be n+K1.

The PDSCH-to-HARQ_feedback timing indicator field may hereinafter be referred to as a HARQ indicator field.

The PUCCH resource indicator field may be a field indicating indexes of one or multiple PUCCH resources included in the PUCCH resource set.

The DCI format 1_1 is configured to include at least some or all of 4A to 4J.
4A) DCI format specification field (Identifier for DCI formats field)
4B) Frequency domain resource assignment field
4C) Time domain resource assignment field
4D) Frequency hopping flag field
4E) Modulation and Coding Scheme field (MCS field)
4F) First CSI request field
4G) PDSCH-to-HARQ feedback timing indicator field
4H) PUCCH resource indicator field.
4J) MVP field

The BWP field may be used to indicate the downlink BAT to which the PDSCH scheduled by the DCI format 1_1 is mapped.

DC1 format 2_0 may include at least one or multiple slot format indicators (SFIs).

In various aspects of the present embodiment, the number of resource blocks indicates the number of resource blocks in the frequency domain unless otherwise specified.

The downlink grant is used at least for scheduling a single PDSCH in a single serving cell.

The uplink grant is used at least for scheduling a single PDSCH in a single serving cell.

A single physical channel may be mapped to a single serving cell. A single physical channel may be mapped to a single BWP configured to a single carrier included in a single serving cell.

In the terminal apparatus 1, one or multiple COntrol REsource SETs (CORESETs) may be configured. The terminal apparatus I monitors the PDCCH in the one or multiple control resource sets. Here, monitoring of the PDCCH in the one or multiple control resource sets may include monitoring of one or multiple PDCCHs corresponding to the one or multiple control resource sets, respectively. Note that the PDCCH may include a set of one or multiple PDCCH candidates and/or one or multiple PDCCH candidates. Also, monitoring of the PDCCH may include monitoring and detecting the PDCCH and/or a DCI format transmitted via the PDCCH.

The control resource set may indicate a time-frequency domain to which one or multiple PDCCHs can be mapped. The control resource set may be an area in which the terminal apparatus 1 monitors the PDCCH. The control resource set may include continuous resources (Localized resources). The control resource set may include non-continuous resources (distributed resources).

In the frequency domain, the unit of mapping of the control resource set may be a resource block. In the frequency domain, for example, the unit of mapping of the control resource set may be six resource blocks. In the time domain, the unit of mapping of the control resource set may be an OFDM symbol in the time domain, for example, the unit of mapping of the control resource set may be one OFDM symbol.

Mapping of the control resource set to the resource block may be provided based at least on the higher layer parameter. The higher layer parameter may include a bitmap for a Resource Block Group (RBG). The resource block group may be provided by six continuous resource blocks.

The number of OFDM symbols included in the control source set may be provided based at least on the higher layer parameter.

A certain control resource set may be a Common control resource set. The common control resource set may be a control resource set configured commonly to multiple terminal apparatuses 1. The common control resource set may be provided at least based on some or all of the MIB, the first system information, the second system information, the common RRC signaling, and a cell ID. For example, the time resource and/or the frequency resource of the control resource set configured to monitor the PDCCH to be used for scheduling the first system information may be provided based at least on the MIB.

The control resource set configured by the MIB is also referred to as CORESET #0. CORESET #0 may be a control resource set of index #0.

A certain control resource set may be a Dedicated control resource set, The dedicated control resource set may be a control resource set configured to be used exclusively for the terminal apparatus 1. The dedicated control resource set may be provided based at least on some or all of the dedicated RRC signaling and values of C-RNTI. A multiple control resource sets may be configured in the terminal apparatus 1, and an index (control resource set index) may be assigned to each of the control resource sets. One or more control channel elements (CCEs) may be configured within the control resource set, and an index (CCE index) may be assigned to each CCE.

The set of PDCCH candidates monitored by the terminal apparatus 1 may be defined in terms of a search space. In other words, the set of PDCCH candidates monitored by the terminal apparatus 1 may be provided by the search space.

The search space may include one or multiple PDCCH candidates at one or multiple Aggregation levels. The aggregation level of the PDCCH candidates ma indicate the number of CCEs included in the PDCCH. The PDDCH candidate may be mapped to one or multiple CCEs.

The terminal apparatus 1 may monitor at least one or multiple search spaces in a slot in which Discontinuous reception (DRX) is not configured. The DRX may be provided based at least on a higher layer parameter. The terminal apparatus 1 may monitor at least one or multiple Search space sets in the slot in which the DRX is not configured. Multiple search space sets may be configured in the terminal apparatus 1. An index (search space set index) may be assigned to each search space set.

The search space set may be configured to include at least one or multiple search spaces. An index (search space index) may be assigned to each search space.

Each search space set may be associated at least with one control resource set. Each search space set may be included in one control resource set. An index of the control resource set associated with the search space set may be provided to each search space set

For each of the search space sets, monitoring periodicity for the search space set may be configured. The monitoring periodicity for the search space set may indicate at least the interval between the slots in which the search space set is monitored by the terminal apparatus 1. A higher layer parameter indicating at least the monitoring periodicity for the search space set may be provided for each search space set.

For each of the search space sets, a monitoring offset for the search space set may be configured. The monitoring offset for the search space set may indicate at least the offset from the reference index (e.g., slot #0) of the index of the slot in which the search space set is monitored by the terminal apparatus 1. A higher layer parameter indicating at least the monitoring offset for the search space set may be provided for each search space set.

For each of the search space sets, a monitoring pattern for the search space set may be configured. The monitoring pattern for the search space set may indicate a leading OFDM symbol for a search space set to be monitored. The monitoring pattern for the search space set may be provided by a bitmap indicating the leading OFDM symbol in one or multiple slots. A higher layer parameter indicating at least the monitoring pattern for the search space set may be provided for each search space set.

A monitoring occasion for the search space set may be provided based at least on some or all of the monitoring periodicity for the search space set, the monitoring offset for the search space set, the monitoring pattern for the search space set, and/or the configuration of DRX.

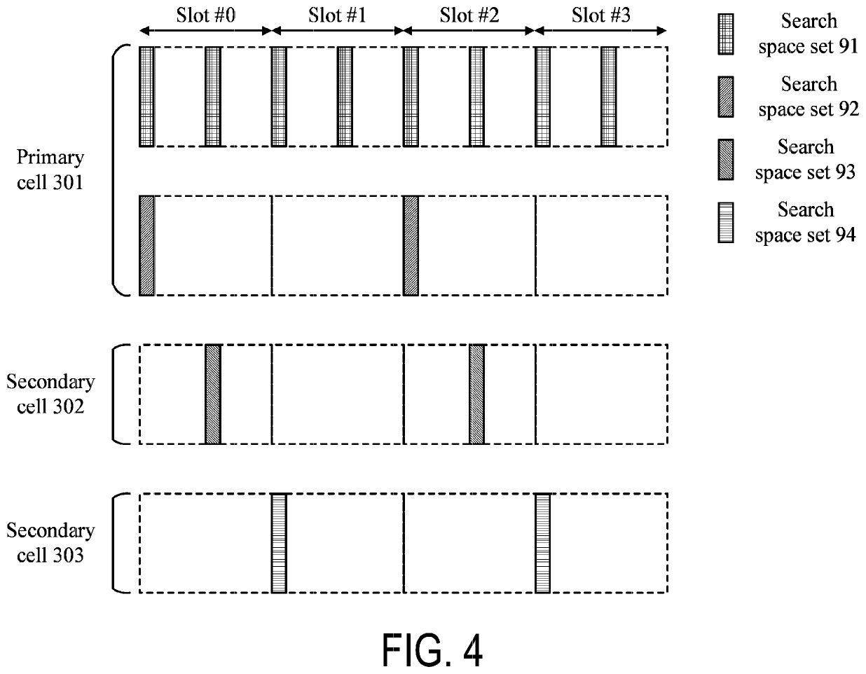

FIG. 4 is a diagram illustrating an example of monitoring occasions for search space sets according to an aspect of the present embodiment. In FIG. 4, a search space set 91 and a search space set 92 are configured for a primary cell 301, a search space set 93 is configured for a secondary cell 302, and a search space set 94 is configured for a secondary cell 303.

In FIG. 4, a block indicated by grid lines indicates the search space set 91, a block indicated by diagonal lines extending to the upper right indicates the search space set 92, a block indicated by diagonal lines extending to the upper left indicates the search space set 93, and a block indicated by horizontal lines indicates the search space set 94.

The monitoring periodicity for the search space set 91 is set to one slot, the monitoring offset for the search space set 91 is set to zero slots, and the monitoring pattern for the search space set 91 is set to [1, 0, 0, 0, 0, 0, 0, 1, 0, 0, 0, 0, 0, 0]. In other words, the monitoring occasion for the search space set 91 is the leading OFDM symbol (OFDM symbol #0) and the eighth OFDM symbol (OFDM symbol #7) in each of the slots.

The monitoring periodicity for the search space set 92 is set to two slots, the monitoring offset for the search space set 92 is set to zero slots, and the monitoring pattern for the search space set 92 is set to [1, 0, 0, 0, 0, 0, 0, 0, 0, 0, 0, 0, 0, 0]. In other words, the monitoring occasion for the search space set 92 is the leading OFDM symbol in each of the even numbered slots (OFDM symbol #0).

The monitoring periodicity for the search space set 93 is set to two slots, the monitoring offset for the search space set 93 is set to zero slots, and the monitoring pattern for the search space set 93 is set to [0, 0, 0, 0, 0, 0, 0, 1, 0, 0, 0, 0, 0, 0]. In other words, the monitoring occasion for the search space set 93 is the eighth OFDM symbol in each of the even numbered slots (OFDM symbol #7).

The monitoring periodicity for the search space set 94 is set to two slots, the monitoring offset for the search space set 94 is set to one slot, and the monitoring pattern for the search space set 94 is set to [1, 0, 0, 0, 0, 0, 0, 0, 0, 0, 0, 0, 0, 0]. In other words, the monitoring occasion for the search space set 94 is the leading OFDM symbol in each of the odd numbered slots (OFDM symbol #0).

A physical resource of the search space includes a Control Channel Element (CCE). The CCE includes a prescribed number of Resource Element Groups (REGs). For example, the CCE may include six REGs. The REG may include one Physical Resource Block (PRB) during one OFDM symbol in other words, the REG may be configured to include 12 Resource Elements (REs). The PRB is also simply referred to as a Resource Block (RB).

The PDSCH is used at least to transmit the transport block. The PDSCH may be used at least to transmit a random access message 2 (random access response). The PDSCH may be used at least to transmit system information including parameters used for initial access.

In FIG. 1, the following downlink physical signals are used for the downlink radio communication. The downlink physical signals may not be used for transmitting information output from a higher layer, but is used by the physical layer.
Synchronization Signal (SS)
DownLink DeModulation Reference Signal (DL DMRS)
Channel State Information-Reference Signal (CSI-RS)
Downlink Phase Tracking Reference Signal (DL PTRS)

The synchronization signal is used for the terminal apparatus 1 to establish synchronization in a frequency domain and/or a time domain of the downlink. The synchronization signal includes a Primary Synchronization Signal (PSS) and a Secondary Synchronization Signal (SSS).

An SS block (SS/PBCH block) is configured to include at least some or all of the PSS, the SSS, and the PBCH.

The DL DIMS is associated with transmission of the PBCH, PDCCH and/or PDSCH. The DL DMRS is multiplexed to the PBCH, the PDCCH and/or the PDSCH. The terminal apparatus 1 may use the DL DMRS corresponding to the PBCH, the PDCCH, or the PDSCH to perform channel compensation of the PBCH, the PDCCH, or the PDSCH.

The CSI-RS may be a signal used at least to calculate channel state information. A pattern of the CSI-RS assumed by the terminal apparatus may be provided at least by a higher layer parameter.

The PTRS may be a signal used at least to compensate for phase noise. A pattern of the PTRS assumed by the terminal apparatus may be provided based at least on a higher layer parameter and/or the DCI.

The DL PTRS may be associated with a DL DMRS group that includes at least an antenna port used for one or multiple DL DMRSs.

The downlink physical channel and the downlink physical signal are also collectively referred to as the downlink signal. The uplink physical channel and the uplink physical signal are also collectively referred to as the uplink signal. The downlink signal and the uplink signal are also collectively referred to as the physical signal. The downlink signal and the uplink signal are also collectively referred to as the signal. The downlink physical channel and the uplink physical channel are collectively referred to as the physical channel. The downlink physical signal and the uplink physical signal are collectively referred to as the physical signal.

A Broadcast CHannel (BCH), an Uplink-Shared CHannel (UL-SCH), and a Downlink-shared CHannel (DL-SCH) are transport channels. A channel used in a Medium Access Control (MAC) layer is referred to as a transport channel. A unit of the transport channel used in the MAC layer is also referred to as a transport block (TB) or a MAC PDU. Control of the Hybrid Automatic Repeat reQuest (HARQ) is performed for each transport block in the MAC layer. The transport block is a unit of data that the MAC layer delivers to the physical layer. In the physical layer, the transport block is mapped to a codeword, and modulation processing is performed for each codeword.

The base station apparatus 3 and the terminal apparatus 1 exchange (transmit and/or receive) higher layer signals in the higher layer. For example, the base station apparatus 3 and the terminal apparatus 1 may transmit and/or receive, in a Radio Resource Control (RRC) layer, RRC signaling (a Radio Resource Control (RRC) message and/or Radio Resource Control (RRC) information). Also, the base station apparatus 3 and the terminal apparatus 1 may transmit and/or receive, in the MAC layer, a MAC Control Element (CE). Here, the RRC signaling and/or the MAC CE is also referred to as the higher layer signaling.

The PUSCH and the PDSCH may be used at least to transmit the RRC signaling and/or the MAC CE. Here, the RRC signaling transmitted from the base station apparatus 3 through the PDSCH may be signaling common to multiple terminal apparatuses 1 in a serving cell. The signaling common to the multiple terminal apparatuses 1 in the serving cell is also referred to as common RRC signaling. The RRC signaling transmitted from the base station apparatus 3 through the PDSCH may be signaling dedicated to a certain terminal apparatus 1 (also referred to as dedicated signaling or UE specific signaling). The signaling dedicated to the terminal apparatus 1 is also referred to as dedicated RRC signaling. A serving cell-specific higher layer parameter may be transmitted by using the signaling common to the multiple terminal apparatuses 1 in the serving cell or the signaling dedicated to a certain terminal apparatus 1. A UE-specific higher layer parameter may be transmitted using signaling dedicated to a certain terminal apparatus 1.

A Broadcast Control CHannel (BCCH), a Common Control CHannel (CCCH), and a Dedicated Control CHannel (DCCH) are logical channels. For example, the BCCH is a higher layer channel used to transmit the MIB. Furthermore, the Common Control CHannel (CCCH) is a higher layer channel used to transmit, information common to the multiple terminal apparatuses 1. Here, the CCCH may be used for a terminal apparatus 1 that is not. RRC-connected, for example. Moreover, a Dedicated Control CHannel (DCCH) is a higher layer channel used at least to transmit dedicated control information to the terminal apparatus 1. Here, the DCCH may be used for a terminal apparatus 1 that is RRC-connected, for example,

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to the PUSCH in the physical channel. The DL-SCH in the transport channel may be mapped to the PDSCH in the physical channel. The BCH in the transport channel may be mapped to the PBCH in the physical channel.

A structural example of the terminal apparatus 1 according to the one aspect of the present embodiment will be described below.

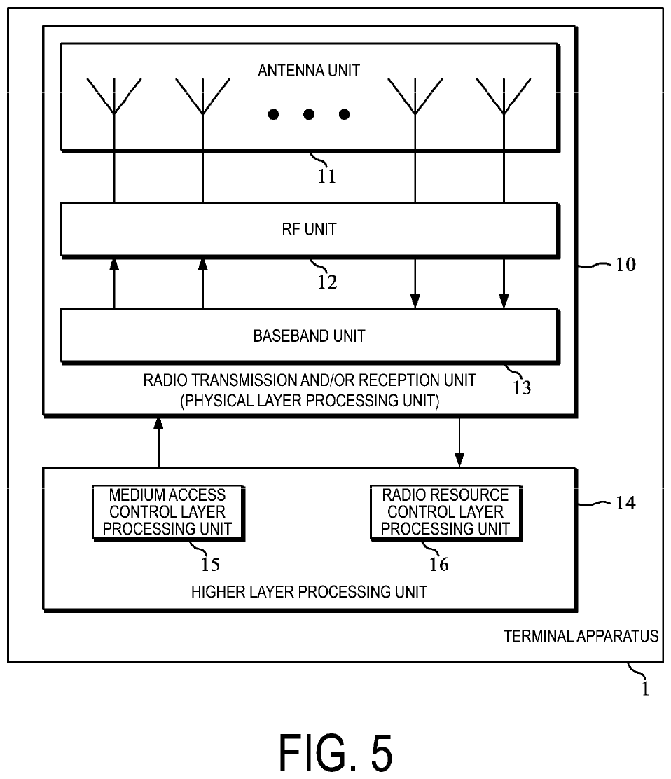

FIG. 5 is a schematic block diagram illustrating a configuration of the terminal apparatus 1 according to an aspect of the present embodiment. As illustrated, the terminal apparatus 1 is configured to include a radio transmission and/or reception unit 10 and a higher layer processing unit 14. The radio transmission and/or reception unit 10 is configured to include at least some or all of an antenna unit 11, a Radio Frequency (RF) unit 12, and a baseband unit 13. The higher layer processing unit 14 is configured to include at least some or all of a medium access control layer processing unit 15 and a radio resource control layer processing unit 16. The radio transmission and/or reception unit 10 is also referred to as a transmitter, a receiver, or a physical layer processing unit.

The higher layer processing unit 14 outputs uplink data (transport block) generated by a user operation or the like to the radio transmission and/or reception unit 10. The higher layer processing unit 14 performs processing of a MAC layer, a Packet Data Convergence Protocol (PDCP) layer, a Radio Link Control (RLC) layer, and an RRE layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. In other words, the radio resource control layer processing unit 16 sets the various configuration information/parameters based on the information indicating the various configuration information/parameters received from the base station apparatus 3. Note that the configuration information may include information related to the processing or configurations of the physical channel, the physical signal (that is, the physical layer), the MAC layer, the PDCP layer, the RLC layer, and the RRC layer. The parameters may be higher layer parameters.

The radio transmission and/or reception unit 10 performs processing of the physical layer, such as modulation, demodulation, coding, and decoding. The radio transmission and/or reception unit 10 demultiplexes, demodulates, and decodes a received physical signal and outputs the decoded information to the higher layer processing unit 14. The radio transmission and/or reception unit 10 generates a physical signal by performing modulation and coding of data and generating a baseband signal (conversion into a time-continuous signal) and transmits the physical signal to the base station apparatus 3.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input, from the RF unit 12 into a digital signal. The baseband unit 13 removes a portion corresponding to a Cyclic Prefix (CP) from the converted digital signal, performs a Fast Fourier Transform (FFT) on the signal from which the CP has been removed, and extracts a signal in the frequency domain.

The baseband unit 13 generates an OFDM symbol by performing Inverse Fast Fourier Transform (IFFT) on the data, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up converts the analog signal into a signal of a carrier frequency, and transmits the up converted signal via the antenna unit 11. Also, the RF unit 12 amplifies power. In addition, the RE unit 12 may have a function of controlling transmit power. The RF unit 12 is also referred to as a transmit power controller.

Hereinafter, a structural example of the base station apparatus 3 according to an aspect of the present embodiment will be described below.

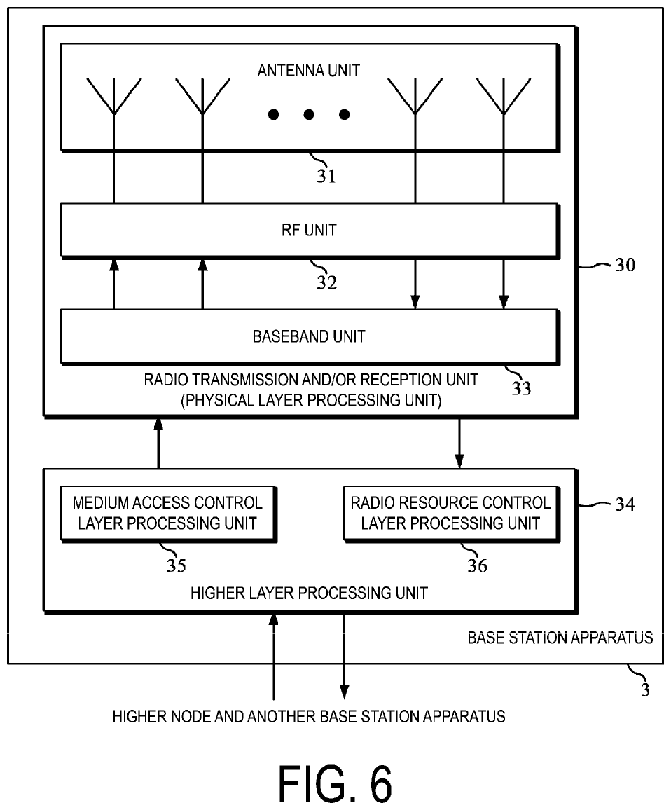

FIG. 6 is a schematic block diagram illustrating a configuration of the base station apparatus 3 according to an aspect of the present embodiment. As illustrated, the base station apparatus 3 is configured to include a radio transmission and/or reception unit 30 and a higher layer processing unit 34. The radio transmission and/or reception unit 30 is configured to include an antenna unit 31, an RF unit 32, and a baseband unit 33. The higher layer processing unit 34 is configured to include a medium access control layer processing unit 35 and a radio resource control layer processing unit 36. The radio transmission and/or reception unit 30 is also referred to as a transmitter, a receiver, or a physical layer processing unit.

The higher layer processing unit 34 performs processing of a MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (transport block) mapped to a PDSCH, system information, an RRC message, a MAC CE, and the like, and outputs the data to the radio transmission and/or reception unit 30. Further, the radio resource control layer processing unit 36 manages various types of configuration information/parameters for each terminal apparatus 1. The radio resource control layer processing unit 36 may set various types of configuration information/parameters for each terminal apparatus 1 via higher layer signals. In other words, the radio resource control layer processing unit 36 transmits/broadcasts information indicating various types of configuration information/parameters. Note that the configuration information may include information related to the processing or configurations of the physical channel, the physical signal (that is, the physical layer), the MAC layer, the PDCP layer, the RLC layer, and the RRC layer. The parameters may he higher layer parameters.

The functionality of the radio transmission and/or reception unit 30 is similar to the functionality of the radio transmission and/or reception unit 10, and description thereof will thus be omitted.

Each of the units having the reference signs 10 to 16 included in the terminal apparatus 1 may be implemented as a circuit. Each of the units having the reference signs 30 to 36 included in the base station apparatus 3 may be implemented as a circuit.

One or multiple pieces of HARQ-ACK information may be multiplexed to a codebook. The codebook of the HARQ-ACK information may be transmitted on the PUCCH. The codebook of the HARQ-ACK may be transmitted on the PUSCH.

A set (association set) of monitoring occasions for the PDCCH may be provided for transmission of HARQ-ACK information transmitted on the PDCCH in a certain slot. The set of monitoring occasions for the PDCCH includes M monitoring occasions for the PDCCH. The set of monitoring occasions for the PDCCH may be provided based at least on one or both of timing K0 and/or timing K1. The set of monitoring occasions for the PDCCH may be provided based at least on some or all of a set of candidate values for timing K0 and/or a set of candidate values of timing K1. The set of candidate values for the timing K0 may be provided based at least on a higher layer parameter. The set of candidate values for the timing K1 may be provided based at least on a higher layer parameter.

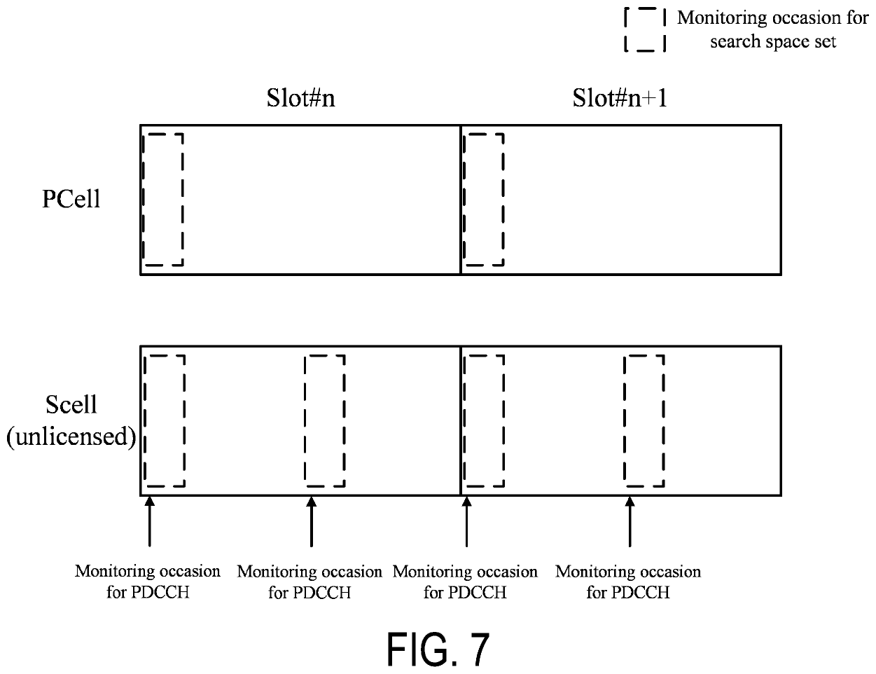

FIG. 7 is a diagram illustrating an example of correspondence between monitoring occasions for a search space set and monitoring occasions for the PDCCH according to an aspect of the present embodiment. In FIG. 7, the monitoring occasions for the search space set in the primary cell correspond to the leading OFDM symbol in the slot, and the monitoring occasions for the search space set in the secondary cell correspond to the leading OFDM symbol in the slot and an intermediate OFDM symbol in the slot (e.g., OFDM symbol #7). In FIG. 7, the monitoring occasions for the PDCCH corresponds to the leading OFDM symbol in slot #n and the intermediate OFDM symbol in slot #n, and the leading OFDM symbol in slot #n+1 and the intermediate OFDM symbol in slot #n+1. In other words, the monitoring occasion for the PDCCH may be defined as the occasion on which the monitoring occasion for the search space set is configured for at least one of one or multiple serving cells, Furthermore, the monitoring occasion for the PDCCH may correspond to the index of the OFDM syMbol for which the monitoring occasion for the search space set is configured for at least one of the one or multiple serving cells.

In the slot, the monitoring occasions for the search space set starting from a certain OFDM symbol index may correspond to the monitoring occasions for the PDCCH starting from the certain OFDM symbol index, The monitoring occasion for the PDCCH starting from a certain OFDM symbol index may correspond to each of the monitoring occasions for the search space set starting from a certain OFDM symbol index.

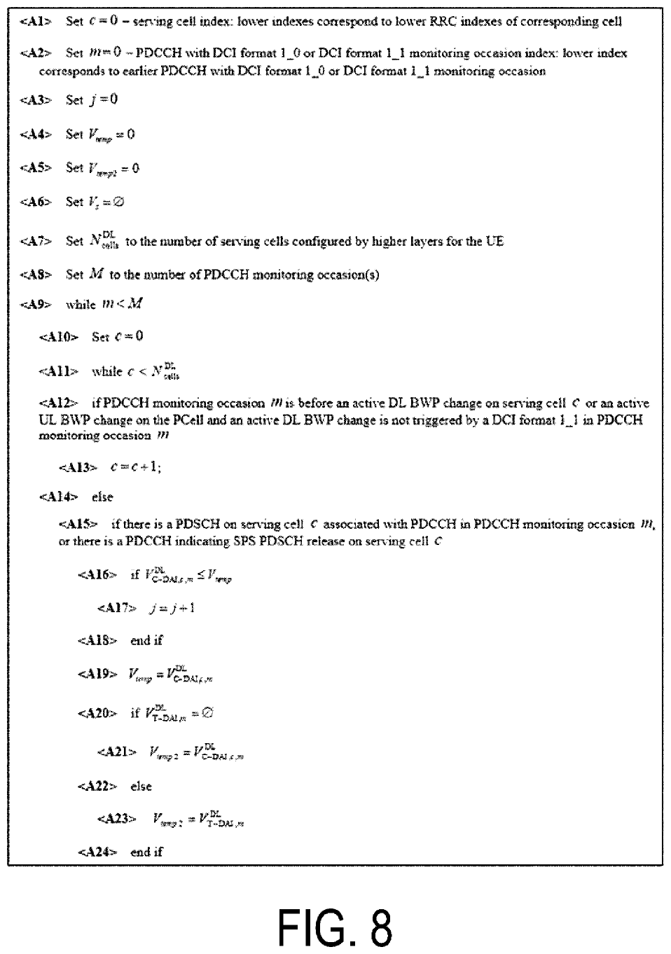

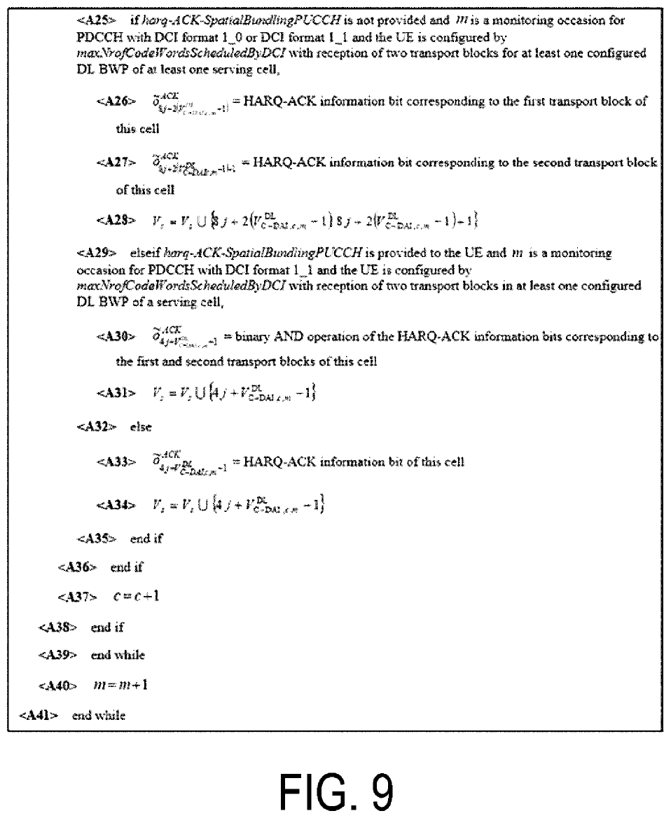

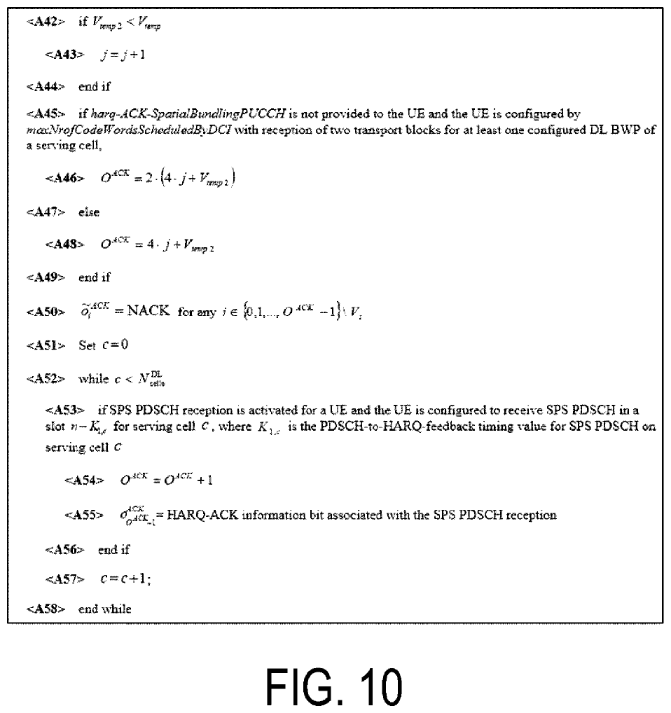

FIG. 8, FIG. 9, and FIG. 10 are diagrams illustrating an example of the procedure of configuration of a codebook of HARQ-ACK information (HARQ-ACK codebook) according to an aspect of the present embodiment. <AX> in FIG. 8, FIG. 9, and FIG. 10 are also referred to as step AX. In FIG. 8, FIG. 9, and FIG. 10, “A=B” may represent that A is set to B. In FIG. 8, FIG. 9, and FIG. 10, “A=B” may represent that B is input to A.

The codebook of the HARQ-ACK information may be provided based at least on some or all of steps A1 to A46.

The codebook of the HARQ-ACK information may be provided based at least on some or all of a set of monitoring occasions for the PDCCH, the value of the UL DAI field, the value of a counter DAI field, and/or a DAI field.

The codebook of the HARQ-ACK information may be provided based at least on some or all of the set of monitoring occasions tor the PDCCH, the UL DAI, counter DAI, and/or total DAI.

In step A1, a serving cell index c is set to 0. The serving cell index may be provided for each serving cell based at least on a higher layer parameter.

In step A2, m=0 is set, m may indicate the index of the monitoring occasion for the PDCCH including DCI format 1_0 or DCI format 1_1.

In step A3, j may be set to 0.

In step A4, Vₜₑₘₚ may be set to 0.

In step AS, Vₜₑₘₚ₂ may be set to 0.

In step A6, Vₛ=φ may be set, φ denotes an empty set.

In step A7, N^{DL}_{cells} may be set to the number of serving cells. The number of serving cells may be the number of serving cells configured for the terminal apparatus 1.

In step A8, M may be set to the number of monitoring occasions for the PDCCH.

In step A9, a first evaluation formula m<M is evaluated. In a case that the first evaluation formula is true, step A10 may be performed. In a case that the first evaluation formula is false, step A34 may be performed.

In step A10, c may be set to 0.

In step A11, a second evaluation formula c<N^{DL}_{cells} is evaluated. In a case that the second evaluation formula is true, step A11 may be performed. In a case that the second evaluation formula is false, step A33 may be performed.

In step A12, in a case that the monitoring occasion m for the PDCCH on the serving cell c is before the switching of an active downlink BWP, step A13 may be performed. In step A12, in a case that an active uplink BWP is switched on the PCell and that switching of the active downlink BWP is not triggered by DCI format 1_1, step A13 may be performed. in a case that all of the above-described two conditions are not satisfied, step A14 may be performed.

In step A13, c may be set to c+1.

At step A14, step A15 may be performed.

In step A15, in a case that there is a PDSCH associated with the PDCCH on the monitoring occasion in for the PDCCH on the serving cell c or there is a PDCCH indicating a release of the SPS PDSCH on the serving cell c, step A16 may be performed.

In step A16, a third evaluation formula V^{DL}_{C-DAI,c,m}Vₜₑₘₚ is evaluated. In a case that the third evaluation formula is true, step A17 may be performed. In a case that the third evaluation formula is false, step A18 may be performed. V^{DL}_{C-DAI,c,m} is the value of the counter Downlink Assignment index (DAI) provided based at least on the PDCCH detected in the monitoring occasion m for the PDCCH on the serving cell c. The counter DAI indicates the accumulated number of PDCCHs detected until the monitoring occasion in for the PDCCH on the serving cell c, included in the M monitoring occasions for the PDCCH, (or may be a value at least associated with the accumulated number). In determining the accumulated number, the indexes of the PDCCHs detected on the M monitoring occasions may be provided first for the serving cell index c and second for the monitoring occasion m for the PDCCH. In other words, the indexes of the PDCCHs detected on the WI monitoring occasions for the PDCCH may first be mapped in order of the serving cell index c and then in order of the monitoring occasion in for the PDCCH (serving cell index first, PDCEEI monitoring occasion second mapping). The counter DAL may be referred to as a Counter Downlink Assignment Index (C-DAI).

In step A17, j may be set to j÷1.

Step A18 may be a step indicating completion of the operation based on the third evaluation formula in step A12.

In step A19, Vₜₑₘₚ may be set to V^{DL}_{C-DAI,c,m}.

In step A20, a fourth evaluation formula V^{DL}_{T-DAI,m}=φ may be evaluated. In a case that the fourth evaluation formula is true, step A21 may be performed. In a case that the fourth evaluation formula is false, step A22 may be performed.

V^{DL}_{T-DAI,m} m may be the value of the total DAI provided based at least on the PDCCH detected on the monitoring occasion m for the PDCCH on the serving cell c. The total DAI may indicate the accumulated number (or a value at least associated with the accumulated number) of PDCCHs detected until the monitoring occasion in for the PDCCH, included in the M monitoring occasions for the PDCCH. The total DAI may be referred to as Total Downlink Assignment Index (T-DAI).

The codebook of the HARQ-ACK information may be multiplexed to the PUSCH scheduled based at least on DCI format 0_1, and in a case of m=M 1, at least V^{DL}_{T-DAI,m} may be replaced with V^{UL}_{DAI}.

In step A21, Vₜₑₘₚ₂ may be set to V^{DL}_{C-DAI,cm}.

At step A22, step A23 may be performed.

In step A23, Vₜₑₘₚ₂ may be set to V^{DL}_{T-DAI,m}.

Step A24 may be a step indicating completion of the operation based on the fourth evaluation formula in step A20.

In step A25, in a case that 1) harq-ACK-SpatialBundlingPUCCH is not provided and that 2) the monitoring occasion m for the PDCCH is a monitoring occasion for PDCCH that includes DCI format 1_0 or Do format 1_1 and that 3) maxNrofCodeWordsScheduledByDCI is configured for at least one IMP of at least one serving cell for reception of two transport blocks, step A26 may be performed, maxNrofCodeWordsScheduledByDCI may be information indicating whether the transmission of two transport blocks on the PDSCH is supported.

In step A26, o^{ACK}ₐ (V^{DL}_{C-DAI,cm}−1))may be set to the value of an HARQ-ACK bit corresponding to the first transport block of the serving cell c. The value of the HARQ-ACK bit being 1 may indicate ACK. The value of the HARQ-ACK bit being 0 may indicate NACK. The first transport block of the serving cell c may be the first transport block included in the PDSCH scheduled by the DCI format included in the PDCCH detected on the monitoring occasion m for the PDCCH on the serving cell c.

In step A27, o^{AcK}ₐ (8j+2(V^{DL}_{C-DAL,cm}−1)+1) may be set to the value of the HARQ-ACK bit corresponding to the second transport block of the serving cell c. The second transport block of the serving cell c may be the second transport block included in the PDSCH scheduled by the DCI format included in the PDCCH detected on the monitoring occasion m for the PDCCH on the serving cell c.

The fact that the PDSCH includes the first transport block and that the PDSCH does not include the second transport block may mean that the PDSCH may include one transport block.

In step A28, Vₛ may be set to VₛU{8j+2(V^{DL}_{C-DAI,cm}−1), 8j+2(V^{DL}_{C-DAI,c,m}−1)+1}, YUZ may indicate a union of a set Y and a set Z, {*} may be a set including *.

In step A29, in a case that 1) harq-ACK-SpatialBundlingPUCCH is provided and that 2) the monitoring occasion m for the PDCCH is a monitoring occasion for PDCCH that includes DCI format 1_1 and that 3) maxNrofCodeWordsScheduledByDCI is configured for at least one BWP of at least one serving cell for reception of two transport blocks, step A30 may be performed.

In step A30, o^{ACK}ₙ (4j+V^{DL}_{C-DAI,c,m}−1) may be set to a value provided by performing a binary AND operation on a first HARQ-ACK bit corresponding to the first transport block of the serving cell c and a second HARQ-ACK bit corresponding to the second transport block of the serving cell c.

In step A31, Vₛ may be set to VₛU{4j+V^{DL}_{C-DAL,c,m}−1}.

In step A32, step A33 may be performed in a case that the conditions in step A25 and the conditions in step A29 are not satisfied.

In step A33, o^{ACK}a(4j+V^{DL}_{C-DAI,c,m}−1) may be set to the value of the first HARQ-ACK bit corresponding to the first transport, block of the serving cell c. In step A33, o^{ACK}ₐ (4j+V^{DL}_{C-DAI,cm}−1) may be set to the value of the HARQ-ACK bit of the serving cell c.

In step A34, Vₛ may be set to VₛU{4j+V^{DL}_{C-DAI,cm}−1}.

Step A35 may be a step indicating completion of the operation in step A25.

Step A36 may be a step indicating completion of the operation in step A15.

In step A37, c may be set to c+1.

Step A38 may be a step indicating completion of the operation in step A12.

In step A39, step All may be performed.

In step A40, in may be set to m+1.

In step A41, step A10 may be performed.

In step A42, a fifth evaluation formula Vₜₑₘₚ₂<Vₜₑₘₚ may be performed. In a case that the fifth evaluation formula is true, step A43 may be performed. In a case that the fifth evaluation formula is false, step A44 may be performed.

In step A43, j may be set to j+1.

Step A44 may be a step indicating completion of step A42.

In step A45, in a case that 1) harq-ACK-SpatialBundlingPUCCH is not provided and that 2) maxNrofCodeWordsScheduledByDCI is configured for at least one BWP of at least one serving cell, step A46 may be performed. In a case that all of the above-described two conditions are not satisfied, step A47 may be performed.

In step A46, O_{ACK} may be set to 2 (4j+Vₜₑₘₚ₂).

In step A47, step A48 may be performed.

In step A48, O_{ACK} may be set to 4j+Vₜₑₘₚ₂.

Step A49 may be a step indicating completion of the operation in step A12.

In step A50, for i_{N} for which i_{N} E {0,1, . . . , O^{ACK}−1}YVₛ is satisfied, o^{ACK}ₐ(i_{N}) may be set to the value of NACK. VYW may indicate a set obtained by removing, from a set V, elements included in a set W. VYW may be the set difference of V with respect to W.

In step A51, c may be set to 0.

In step A52, a seventh evaluation formula c<N^{DL}_{cells} is evaluated. In a case that the seventh evaluation formula is true, step A54 may be performed. In a case that the second evaluation formula is false:, step A58 may be performed.

In step A54, in a case that a configuration is made such that a PDSCH (SPS PDSCH) scheduled by configured grant in one or multiple slots on NI monitoring occasions for the PDCCH is received and that the transmission of the SPS PDSCH is activated, step A54 may be performed.

In step A54, O^{ACK} may be set to O^{ACK}+1. In step A44, O_{ACK} may be set to O^{ACK}+N_{SPS}. N_{SPS} may be the number of SPS PDSCHs configured to be received on M monitoring occasions 1001 for the PDCCH.

In step A55, o^{ACK}a(o^{ACK}a−1) may be set to the value of the HARQ-ACK bit corresponding to the transport block included in the SPS PDSCH. In step A45, o^{ACK}ₐ (o^{ACK}ₐ₋ᵢ_{SPS}) may be set to the value of the HARQ-ACK bit corresponding to the transport block included in the SPS PDSCH. TSPS may satisfy the condition of i_{SPS} ϵ {0,1, . . . , N_{SPS}−1}. In step A45, o^{ACK}a (o^{ACK}ₐ−1) may be set to a value provided by performing a binary AND operation on HARQ-ACK, bits corresponding to transport blocks included in each of the one or multiple SPS PDSCHs configured to be received on M monitoring occasions for the PDCCH.

Step A56 may be a step indicating completion of the operation in step A53.

In step A57, c may be set to c+1.

Step A58 may be a step indicating completion of the operation in step A52.

Each of the first to seventh evaluation formulae is also referred to as an evaluation formula. The evaluation formula being true may mean that the evaluation formula is satisfied. The evaluation formula being false may mean that the evaluation formula is not true. The evaluation formula being false may mean that the evaluation formula is not satisfied.

The terminal apparatus 1 may perform Carrier sense prior to transmission of a physical signal. Also, the base station apparatus 3 may perform carrier sense prior to transmission of a physical signal. The carrier sense may be to perform Energy detection on a Radio channel, Whether the physical signal can be transmitted may be provided based on the carrier sense performed prior to transmission of the physical signal. In a case that the amount of energy detected in carrier sense performed prior to transmission of a physical signal is greater than a prescribed threshold value, for example, the transmission of the physical channel may not be performed, or it may be determined that the transmission is not possible. Also, in a case that the amount of energy detected in the carrier sense performed prior to the transmission of the physical signal is smaller than the prescribed threshold value, the transmission of the physical channel may be performed, or it may be determined that the transmission is possible. Moreover, in a case that the amount of energy detected in the carrier sense performed prior to the transmission of the physical signal is equal to the prescribed threshold value, the transmission of the physical channel may be performed or may not be performed. In other words, in a case that the amount of energy detected in the carrier sense performed prior to the transmission of the physical signal is equal to the prescribed threshold value, it may be determined that the transmission is not possible, or it may be determined that the transmission is possible.

A procedure in which Whether the transmission of the physical channel is possible based on the carrier sense is also referred to as Listen Before Talk (LBT). A situation in which the transmission of the physical signal is determined to be not possible as a result of the LBT is also referred to as a busy state or busy. For example, the busy state may be a state in which the amount of energy detected in the carrier sense is greater than the prescribed threshold value. In addition, the situation in which the transmission of the physical signal is determined to be possible as a result of the LBT is also referred to as an idle state or idle. For example, the idle state may be a state in Which the amount of energy detected in the carrier sense is smaller than the prescribed threshold value.

The terminal apparatus 1 may multiplex uplink control information (UCI) to the PUCCH and transmit the PUCCH. The terminal apparatus I may multiplex the UCI to the PUSCH and transmit the PUSCH. The UCI may include at least one of downlink Channel State information (CSI), a Scheduling Request (SR) indicating a request for a PUSCH resource, and a Hybrid Automatic Repeat request ACKnowledgement (HARQ-ACK) for downlink data (a Transport block, a Medium Access Control Protocol Data Unit (MAC PDU), a Downlink-Shared Channel (DL-SCH), and/or a Physical Downlink Shared Channel (PDSCH)).

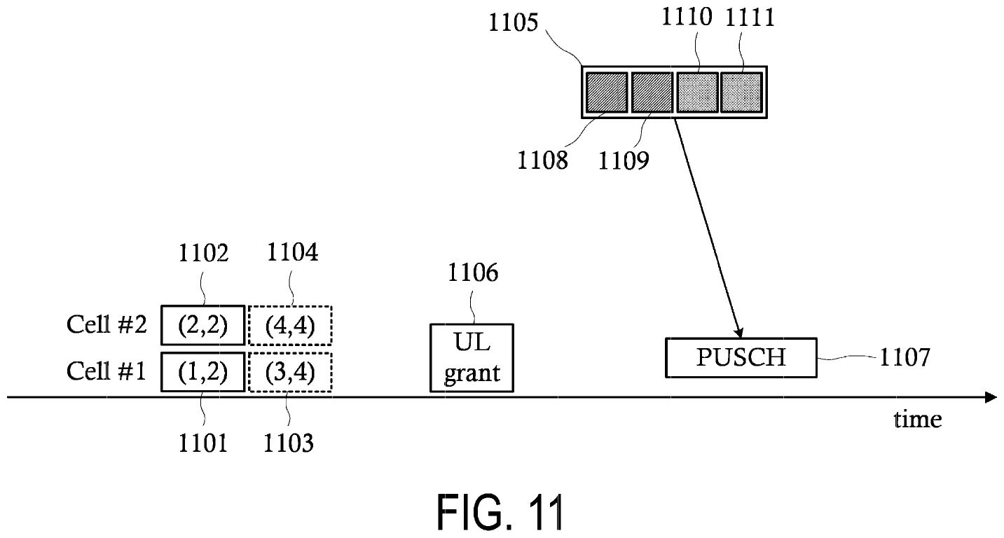

FIG. 11 is a diagram illustrating functions of the UL DAI according to an aspect of the present embodiment. As illustrated, a PDSCH 1101, a PDSCH 1102, a PDSCH 1103, and a PDSCH 1104 are respectively provided by downlink scheduling to pairs (1,2), (2,2), (3,4), and (4,4) of the counter DAI (C-DAI) and the total DAI (T-DAI). The terminal apparatus 1 attempts to generate a HARQ-ACK codebook 1105 for reception of the multiple PDSCHs, and determines the size of the HARQ-ACK codebook 1105 based at least on the UL DAI in advance. The information bits 1108, information bits 1109, information bits 1110, and information bits 1111 in the HARQ-ACK codebook 1105 respectively correspond to the PDSCH 1101, the PDSCH 1102, the PDSCH 1103, and the PDSCH 1104. The UL. DAI may be provided by the last total DAI in the time domain. For example, in FIG. 11, the UL DAI has a value of 4. The UL DAI may be notified to the terminal apparatus 1 via the first UL 17A1 field and/or the second UL 17A1 field included in an uplink DCI format 1106 scheduling the PUSCH 1107. The terminal apparatus 1 may multiplex the HARQ-ACK codebook 1105 to the PUSCH 1107 and report (transmit) the PUSCH 1107. The size of the UL DAI field the number of bits in the UL DAI field) may be provided based at least on the maximum number of PUSCHs that can be scheduled by one uplink DCI format. Here, the maximum number of PUSCHs that can be scheduled by one uplink DCI format may be indicated by a value included in the higher layer parameters. The UL DAI field may indicate the maximum number of UL DAIs of the PUSCHs that can be scheduled by one uplink DCI format.

Additionally, the number of UL DAI fields included in one uplink DCI format may be provided based at least on the maximum number of PUSCHs that can be scheduled by the one uplink DCI format. For example, the number of UL DAL fields included in one uplink DCI format may be equal to the maximum number of PUSCHs that can be scheduled by the one uplink DCI format. The Nth UL DAI field in the multiple UL DAI fields included in one uplink DCI format may be applied to the Nth from the leading PUSCH, included in the multiple PUSCHs scheduled by the one uplink DCI format.

Hereinafter, functions of the UL DAI will be described taking a specific example. For example, in a case that the terminal apparatus 1 fails to detect the DCI format for scheduling PDSCH 1103 and the DCI format for scheduling PDSCH 1104, the terminal apparatus 1 determines the size of the HARQ-ACK codebook 1105 based on UL DAI=4, and can provide the information bits 1110 and 1111 respectively corresponding to reception of PDSCH 1103 and PDSCH 1104.

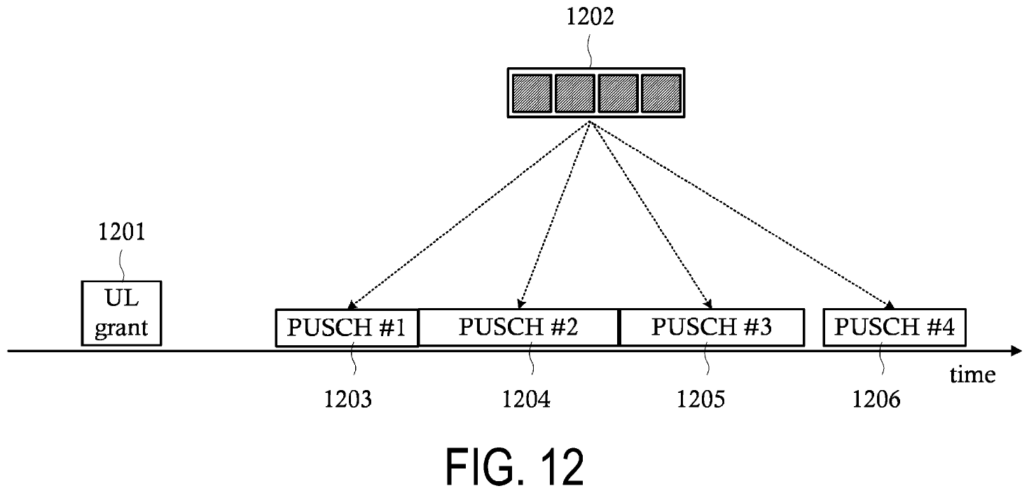

FIG. 12 is a diagram illustrating a method for selecting a PUSCH that maps the HARQ-ACK codebook to which the UL DAI is applied according to an aspect of the present embodiment. As illustrated, the uplink DCI format 1201 schedules multiple first PUSCHs including a PUSCH 1203, a PUSCH 1204, a PUSCH 1205, and a PUSCH 1206. The size of the HARQ-ACK codebook 1202 mapped to any of one or multiple second PUSCHs included in the multiple first PUSCHs may be provided based at least on the UL DAI included in the uplink Del format 1201. The one or multiple second PUSCHs may be provided based at least on some or all of the selection method 1, the selection method 2, the selection method 3, the selection method 4, the selection method 5, the selection method 6, the selection method 7, and the selection method 8. The one or multiple second PUSCHs may be provided based at least on any of the indication method 1, the indication method 2, the indication method 3, and the indication method 4.

Here, the multiple first PUSCHs may be mapped to one slot. Additionally, each of the multiple first PUSCHs may be mapped to either of the two slots. In addition, each of the multiple first PUSCHs may be mapped to different slots.

The terminal apparatus 1 may map the HARQ-ACK codebook 1202 to the one or multiple second PUSCHs included in the multiple first PUSCHs. The one or multiple second PUSCHs may be provided based at least on some or all of the selection method 1, the selection method 2, the selection method 3, the selection method 4, the selection method 5, the selection method 6, the selection method 7, and the selection method 8. The one or multiple second PUSCHs may be provided based at least on any of the indication method 1, the indication method 2, the indication method 3, and the indication method 4.

The term first multiple PUSCHs refers to a set of multiple PUSCHs. The expression one or multiple second PUSCHs included in the multiple first PUSCHs means that the set of multiple first PUSCHs includes a set of the one or multiple second PUSCHs, The terminal apparatus 1 may map the HARQ-ACK codebook 1202 to one or multiple PUSCHs included in the set of multiple first PUSCHs based at least on some or all of the selection method 1, the selection method 2, the selection method 3, the selection method 4, the selection method 5, the selection method 6, the selection method 7, and the selection method 8. In the set of multiple first PUSCHs, one or more PUSCHs to which the HARQ-ACK codebook is mapped may be referred to as second PUSCHs. The terminal apparatus 1 determines one or multiple first PUSCHs included in the set of multiple first PUSCHs and to which the HARQ-ACK codebook is mapped to be second PUSCHs.

The selection method 1 described above may select the leading PUSCH of the multiple first PUSCHs scheduled by the uplink DCI format. For example, in FIG. 12, the PUSCH 1203 may be selected. Selection of the leading PUSCH may involve consideration for results of LBT.

For example, in a case that the terminal apparatus 1 detects a result of LBT indicating a busy state on the PUSCH 1203 (i.e., the result of channel sensing indicates the busy state in a case of transmission of the PUSCH 1203) and detects a result of LBT indicating idle on the PUSCH 1204, the PUSCH 1204 may be selected as the leading PUSCH. Alternatively, in the selection of the leading PUSCH, the leading PUSCH in the scheduled slots may be selected regardless of the results of LBT. In other words, the selection method 1 may select the leading PUSCH (e.g., the PUSCH 1203) regardless of results of channel sensing performed on at least one of the multiple PUSCHs. In this way, selection of the leading PUSCH allows for a reduction in delay in HARQ-ACK reporting.

The selection method 2 described above may select the second from the leading PUSCH of the multiple first PUSCHs scheduled by the uplink DCI format. For example, in FIG. 12, the PUSCH 1204 may be selected. Selection of the second from the leading PUSCH may involve consideration for results of LBT. For example, in a case that the terminal apparatus 1 detects a result of LBT indicating a busy state on the PUSCH 1203, detects a result of LBT indicating idle on the PUSCH 1204, and detects a result of LBT indicating an idle state on the PUSCH 1205, the PUSCH 1205 may be selected as the second from the leading PUSCH. Alternatively, in the selection of the leading PUSCH, the second from the leading PUSCH in the scheduled slots may be selected regardless of the results of LBT. That is, the selection method 2 may select the second. PUSCH (e.g., PUSCH 1204) from the leading PUSCH regardless of the results of channel sensing performed on at least one of the multiple PUSCHs. In this way, by selecting the second from the leading PUSCH, tradeoff between the delay in the HARQ-ACK reporting and the probability of PUSCH transmission can be maintained.

The selection method 3 described above may select, based at least on preconfigured indexes, a PUSCH of the multiple first PUSCHs scheduled by the uplink DCI format. In FIG. 12, the PUSCH 1203, the PUSCH 1204, the PUSCH 1205, and the PUSCH 1206 are respectively assigned indexes of 0, 1, 2, and 3. For example, in a case that the preconfigured indexes are 0 and 1, the PUSCH 1203 and the PUSCH 1204 corresponding to the preconfigured indexes may be selected. For example, in a case that the preconfigured indexes are 0 and 1, the PUSCH 1205 and the PUSCH 1206, which are other than the PUSCHs corresponding to the preconfigured indexes, may be selected. In a case that the terminal apparatus 1 detects a result of LBT indicating the busy state on the selected PUSCH, the terminal apparatus 1 need not transmit the PUSCH. The preconfigured indexes may be configured based at least on a parameter included in the higher layer parameters. In this way, by selecting the PUSCH based at least on the preconfigured indexes, the flexibility of the configuration and/or the reliability of the uplink can be improved.

The selection method 4 described above may be a selection method for aperiodic CSI. For example, in FIG. 12, in a case that the PUSCH 1205 is selected for aperiodic CSI reporting, the HARQ-ACK codebook to which the UL DAI is applied may be mapped to the PUSCH 1205. For example, in a case that the PUSCH 1205 is selected for aperiodic CSI reporting, the HARQ-ACK codebook to which the UL DAI is applied may be mapped to the PUSCH 1203 and the PUSCH 1204, which are other than PUSCH 1205. In the case that the terminal apparatus 1 detects a result of LBT indicating the busy state on the selected PUSCH, the terminal apparatus I need not transmit the PUSCH.

The selection method for aperiodic CSI may be a method for selecting a PUSCH for multiplexing aperiodic CSI based at least on a CSI request field included in the uplink DCI format. In this way, downlink control overhead can be reduced.

The selection method 5 described above may select the last PUSCH of the multiple first PUSCHs scheduled by the uplink DCI format. Here, the last PUSCH may be the last PUSCH with respect to the multiple first PUSCHs. For example, in FIG. 12, the PUSCH 1206 may be selected. The last PUSCH may be the last PUSCH with respect to continuous PUSCHs starting from the leading PUSCH (e.g., the PUSCH 1203, the PUSCH 1204, and the PUSCH 1205) of the multiple first PUSCHs, For example, the PUSCH 1205 may be selected as the last PUSCH. In a case of detecting a result of LBT indicating the busy state on the last PUSCH, the terminal apparatus 1 need not transmit the PUSCH. In other words, the selection method 5 may be the last PUSCH (e.g., the PUSCH 1206) regardless of the results of channel sensing performed on at least one of the multiple first PUSCHs. Thus, selecting the last PUSCH as described above provides multiple LBT occasions, enabling an increase in the probability of PUSCH transmission.

The selection method 6 described above may select the second to the last PUSCH of the multiple first PUSCHs scheduled by the uplink DCI format. For example, in FIG. 12, the PUSCH 1205 may be selected. In a case of detecting a result of LBT indicating the busy state on the second to the last PUSCH, the terminal apparatus 1 need not transmit the PUSCH. In other words, the selection method 6 may select the second to the last PUSCH PUSCH 1205) regardless of the result of channel sensing performed on at least one of the multiple first PUSCHs. By selecting the second to the last PUSCH as described above, tradeoff between the delay in the HARQ-ACK reporting and the probability of PUSCH transmission can be maintained.

In a case that an attempt is made to select the last PUSCH or the second to the last PUSCH, the continuity of the time domain may be or need not be considered for the multiple first PUSCHs. In other words, whether there is a gap between the PUSCHs may be or need not be considered.

The selection method 7 described above may be a method for selecting a PUSCH indicating transmission of an HARQ-ACK codebook and included in the multiple first PUSCHs scheduled by the uplink DCI format. The PUSCH indicating the transmission of the ACK codebook may be the PUSCH on which the HARQ-ACK codebook is transmitted. For example, the base station apparatus 3 may transmit the HARQ-ACK codebook to one of the one or multiple PUSCHs scheduled by one uplink DCI format. Additionally, the terminal apparatus 1 may expect that the HARQ-ACK codebook is transmitted to one of the one or multiple PUSCHs scheduled by one uplink DCI format. The terminal apparatus 1 need not expect that the HARQ-ACK codebook is transmitted to two or more of the one or multiple PUSCHs scheduled by one uplink DCI format. By selecting the PUSCH indicating the transmission of the HARQ-ACK codebook as described above, overlapping indications can be avoided.

The selection method 8 described above may be a method for selecting multiple PUSCHs included in the multiple first PUSCHs scheduled by the uplink DCI format, In other words, two or more PUSCHs may be selected. The multiple PUSCHs may be the leading PUSCH and the second from the leading PUSCH. For example, in FIG. 12, the PUSCH 1203 and the PUSCH 1204 may be selected. The multiple PUSCHs may be the last PUSCH and the second to the last PUSCH. For example, the PUSCH 1205 and the PUSCH 1206 may be selected. The multiple PUSCHs may be the leading PUSCH and the last PUSCH. For example, in FIG. 12, the PUSCH 1203 and the PUSCH 1206 may be selected. The multiple PUSCHs may be the second from the leading PUSCH and the second to the last PUSCH. For example, in FIG. 12, the PUSCH 1204 and the PUSCH 1205 may be selected. The multiple PUSCHs may be selected based at least on preconfigured indexes. The preconfigured indexes may always include an index for the second from the leading PUSCH. The preconfigured indexes may always include an index for the last PUSCH. The multiple PUSCHs may be multiple first PUSCHs scheduled by the uplink DCI format. In other words, the value of the UL DAI field included in the uplink DCI format may be applied to multiple UL DAIs scheduled by the uplink DCI format, By selecting multiple PUSCHs as described above, the reliability of the uplink can be improved.

The indication method 1 described above may be indicated by the DCI format. For example, the indication method 1 may be indicated by the uplink DCI format (e.g., a DCI format including the UL DAI). For example, the indication method 1 may be indicated by a DCI format different from the uplink DCI format, The indication method 2 described above may be indicated by a MAC CE. The indication method 3 described above may be indicated by RRC signaling, The indication method 4 described above may be an indication method for the reporting of aperiodic CSI described above.

The indication method for aperiodic CSI may be a method for notifying, via the CSI request field included in the uplink DCI format, the terminal apparatus I of a selection for multiplexing of the aperiodic CSI to any of the PUSCHs. In a case of detecting an uplink DCI format for triggering a certain aperiodic CSI trigger state, the terminal apparatus 1 may perform aperiodic CSI reporting by using the PUSCH to be scheduled.

The reporting of the aperiodic CSI may be multiplexed to any one of the one or multiple PUSCHs scheduled by the uplink DCI format For example, the reporting of the aperiodic CSI may be multiplexed to the leading PUSCH of the one or multiple PUSCHs scheduled by the uplink DCI format. Additionally, the reporting of the aperiodic CSI may be multiplexed to the second from the leading PUSCH, which is included in the one or multiple PUSCHs scheduled by the uplink DCI format. In addition, the reporting of the aperiodic CSI may be multiplexed to the last PUSCH of the one or multiple PUSCHs scheduled by the uplink DCI format. Additionally, the reporting of the aperiodic CSI may be multiplexed to the second to the last PUSCH of the one or multiple PUSCHs scheduled by the uplink DCI format. In addition, the reporting of the aperiodic CSI may be multiplexed to a PUSCH with a preconfigured index included in the one or multiple PUSCHs scheduled by the uplink DCI format.

A configuration may be made as to whether the HARQ-ACK codebook to which the UL DAI is applied is mapped to each of the PUSCHs scheduled by the uplink DCI format. in a case that multiple PUSCHs are scheduled by the uplink DCI format, the HARQ-ACK codebook may be dropped. In other words, in FIG. 12, the HARQ-ACK codebook 1202 need not be transmitted.

Various aspects of apparatuses according to an aspect of the present embodiment will be described below,

(1) In order to achieve the aforementioned object, aspects of the present invention provide the following measures. Specifically, the first aspect of the present invention provides a terminal apparatus configured to receive a PDCCH and to transmit one or multiple first PUSCHs scheduled based at least on a DCI format included in the PDCCH, wherein a size of an HARQ-ACK codebook to be mapped to any of one or multiple second PUSCHs included in the one or multiple first PUSCHs is provided based at least on a UL DAI included in the DCI format, the one or multiple second PUSCHs are provided based at least on some or all of a selection method 1, a selection method 2, a selection method 3, a selection method 4, a selection method 5, a selection method 6, a selection method 7, and a selection method 8, the selection method 1 is a method for selecting a starting PUSCH, the selection method 2 is a method for selecting a PUSCH immediately subsequent to the starting PUSCH, the selection method 3 is a method for selecting a PUSCH with a preconfigured index, the selection method 4 is a selection method for aperiodic CSI, the selection method 5 is a method for selecting an ending PUSCH, the selection method 6 is a method for selecting a PUSCH immediately preceding the ending PUSCH, the selection method 7 is a method for selecting a PUSCH indicating transmission of the HARQ-ACK codebook, the selection method 8 is a method for selecting multiple PUSCHs, a method for indicating the selected PUSCH is any of an indication method 1, an indication method 2, an indication method 3, and an indication method 4, the indication method 1 is a method for indication by the DCI format, the indication method 2 is a method for indication by a MAC CE, the indication method 3 is a method for indication by RRC signaling, and the indication method 4 is a method for indication for the aperiodic CSI.

(2) A second aspect of the present invention provides a base station apparatus configured to transmit a PDCCH and to receive one or multiple first PUSCHs scheduled based at least on a DCI format included in the PDCCH, wherein a size of an HARQ-ACK codebook to be mapped to any of one or multiple second PUSCHs included in the one or multiple first PUSCHs is provided based at least on a UL DAI included in the DCI format, the one or multiple second PUSCHs are provided based at least on some or all of a selection method 1, a selection method 2, a selection method 3, a selection method 4, a selection method 5, a selection method 6, a selection method 7, and a selection method 8, the selection method 1 is a method for selecting a starting PUSCH, the selection method 2 is a method for selecting a PUSCH immediately subsequent to the starting PUSCH, the selection method 3 is a method for selecting a PUSCH with a preconfigured index, the selection method 4 is a selection method for aperiodic CSI, the selection method 5 is a method for selecting an ending PUSCH, the selection method 6 is a method for selecting a PUSCH immediately preceding the ending PUSCH, the selection method 7 is a method for selecting a PUSCH indicating transmission of the HARQ-ACK codebook, the selection method 8 is a method for selecting multiple PUSCHs, a method for indicating the selected PUSCH is any of an indication method 1, an indication method 2, an indication method 3, and an indication method 4, the indication method 1 is a method for indication by the DCI format, the indication method 2 is a method for indication by a MAC CE, the indication method 3 is a method for indication by RRC signaling, and the indication method 4 is a method for indication for the aperiodic CSI.

Each of the program running on a base station apparatus 3 and a terminal apparatus I according to the present invention may be a program (a program that causes a computer to function) that controls a Central Processing Unit (CPU) and the like, in such a manner as to implement the functions of the aforementioned embodiment according to the present invention, Also, the information handled in these apparatuses is temporarily loaded into a Random Access Memory (RAM) while being processed, is then stored in a Hard. Disk Drive (HDD) and various types of Read Only Memory (ROM) such as a Flash ROM, and is read, modified, and written by the CPU, as necessary.

Note that the terminal apparatus I and the base station apparatus 3 according to the aforementioned embodiment may be partially implemented by a computer. In such a case, a program for implementing such control functions may be recorded on a computer-readable recording medium to cause a computer system to read and execute the program recorded on this recording medium.

Note that it is assumed that the “computer system” mentioned here refers to a computer system built into the terminal apparatus 1 or the base station apparatus 3, and the computer system includes an OS and hardware components such as a peripheral device. Furthermore, a “computer-readable recording medium” refers to a portable medium such as a flexible disk, a magneto-optical disk, a ROM, a CD-ROM, and the like, and a storage device such as a hard disk built into the computer system.

Moreover, the “computer-readable recording medium” may include a medium that dynamically retains the program for a short period of time, such as a communication wire that is used to transmit the program over a network such as the Internet or over a communication line such as a telephone line, and a medium that retains the program for a certain period of time, such as a volatile memory within the computer system which functions as a server or a client in a case that the program is transmitted via the communication wire. Furthermore, the aforementioned program may be configured to implement part of the functions described above, and also may be configured to be capable of implementing the functions described above in combination with a program already recorded in the computer system.

The terminal apparatus 1 may include at least one processor and at least one memory including computer program instructions (computer programs). The memory and computer program instructions (computer programs) may be configured to cause the terminal apparatus 1 to perform the operations and processing described above in the embodiments by using a processor. The base station apparatus 3 may include at least one processor and at least one memory including computer program instructions (computer programs). The memory and computer program instructions (computer programs) may be configured to cause the base station apparatus 3 to perform the operations and processing described above in the embodiments by using a processor.

Furthermore, the base station apparatus 3 according to the above-described embodiment may be achieved as an aggregation (apparatus group) including multiple apparatuses. Each of the apparatuses included in such an apparatus group may include each function, or some or all portions of each functional block of the base station apparatus 3 according to the aforementioned embodiment, As the apparatus group, it is only necessary to have a complete set of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have some or all of the functions of a higher node for an eNodeB and/or a gNB.

Also, some or all portions of each of the terminal apparatus 1 and the base station apparatus 3 according to the aforementioned embodiment may be implemented as an LSI which is a typical integrated circuit or may be implemented as a chip set. The functional blocks of each of the terminal apparatus 1 and the base station apparatus 3 may be individually implemented as a chip, or some or all of the functional blocks may be integrated into a chip. A circuit integration technique is not limited to the LSI, and may be implemented with a dedicated circuit or a general-purpose processor. Moreover, in a case that with advances in semiconductor technology, a circuit integration technology with which an LSI is replaced appears, it is also possible to use an integrated circuit based on the technology.

In addition, although the aforementioned embodiments have described the terminal apparatus as an example of a communication apparatus, the present invention is not limited to such a terminal apparatus, and is applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope not depart from the gist of the present invention. Furthermore, in the present invention, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

1. A terminal apparatus comprising:
a receiver configured to receive a PDCCH; and
a transmitter configured to transmit one or multiple first PUSCHs scheduled based at least on a DCI format included in the PDCCH, wherein
a size of an HARQ-ACK codebook to be mapped to any of one or multiple second PUSCHs included in the one or multiple first PUSCHs is provided based at least on a UL DAI included in the DCI format,
the one or multiple second PUSCHs are provided based at least on sonic or all of a selection method 1, a selection method 2, a selection method 3, a selection method 4, a selection method 5, a selection method 6, a selection method 7, and a selection method 8,
the selection method 1 is a method for selecting a starting PUSCH,
the selection method 2 is a method for selecting a PUSCH immediately subsequent to the starting PUSCH,
the selection method 3 is a method for selecting a PUSCH with a preconfigured index,
the selection method 4 is a selection method for aperiodic CSI,
the selection method 5 is a method for selecting an ending PUSCH,
the selection method 6 is a method for selecting a PUSCH immediately preceding the ending PUSCH,
the selection method 7 is a method for selecting a PUSCH indicating transmission of the HARQ-ACK codebook,
the selection method 8 is a method for selecting multiple PUSCHs,
a method for indicating the selected PUSCH is any of an indication method 1, an indication method 2, an indication method 3, and an indication method 4,
the indication method 1 is a method for indication by the DCI format,
the indication method 2 is a method for indication by a MAC CE,
the indication method 3 is a method for indication by RRC signaling, and
the indication method 4 is a method for indication for the aperiodic CSI.

2. A base station apparatus comprising:
a transmitter configured to transmit a PDCCH; and
a receiver configured to receive one or multiple first PUSCHs scheduled based at least on a DCI format included in the PDCCH, wherein
a size of an HARQ-ACK codebook to be mapped to any of one or multiple second PUSCHs included in the one or multiple first PUSCHs is provided based at least on a UL DAI included in the DCI format,
the one or multiple second PUSCHs are provided based at least on some or all of a selection method 1, a selection method 2, a selection method 3, a selection method 4, a selection method 5, a selection method 6, a selection method 7, and a selection method 8,
the selection method 1 is a method for selecting a starting PUSCH,
the selection method 2 is a method for selecting a PUSCH immediately subsequent to the starting PUSCH,
the selection method 3 is a method for selecting a PUSCH with a preconfigured index,
the selection method 4 is a selection method for aperiodic CSI,
the selection method 5 is a method for selecting an ending PUSCH,
the selection method 6 is a method for selecting a PUSCH immediately preceding the ending PUSCH,
the selection method 7 is a method for selecting a PUSCH indicating transmission of the HARQ-ACK codebook,
the selection method 8 is a method for selecting multiple PUSCHs,
a method for indicating the selected PUSCH is any of an indication method 1, an indication method 2, an indication method 3, and an indication method 4,
the indication method 1 is a method for indication by the DCI format,
the indication method 2 is a method for indication by a MAC CE,
the indication method 3 is a method for indication by RRC signaling, and
the indication method 4 is a method for indication for the aperiodic CSI.

3. A communication method used for a terminal apparatus, the communication method comprising the step of:
receiving a PDCCH and transmitting one or multiple first PUSCHs scheduled based at least on a Do format included in the PDCCH, wherein
a size of an HARQ-ACK codebook to be mapped to any of one or multiple second PUSCHs included in the one or multiple first PUSCHs is provided based at least on a UL DAI included in the DCI format,
the one or multiple second PUSCHs are provided based at least on some or all of a selection method 1, a selection method 2, a selection method 3, a selection method 4, a selection method 5, a selection method 6, a selection method 7, and a selection method 8,
the selection method 1 is a method for selecting a starting PUSCH,
the selection method 2 is a method for selecting a PUSCH immediately subsequent to the starting PUSCH,
the selection method 3 is a method for selecting a PUSCH with a preconfigured index,
the selection method 4 is a selection method for aperiodic
the selection method 5 is a method for selecting an ending PUSCH,
the selection method 6 is a method for selecting a PUSCH immediately preceding the ending PUSCH,
the selection method 7 is a method for selecting a PUSCH indicating transmission of the HARQ-ACK codebook,
the selection method 8 is a method for selecting multiple PUSCHs,
a method for indicating the selected PUSCH is any of an indication method 1, an indication method 2, an indication method 3, and an indication method 4,
the indication method 1 is a method for indication by the DCI format,
the indication method 2 is a method for indication by a MAC CE,
the indication method 3 is a method for indication by RRC signaling, and
the indication method 4 is a method for indication for the aperiodic CSI.

4. A communication method used for a base station apparatus, the communication method comprising the step of:
transmitting a PDCCH and receiving one or multiple first PUSCHs scheduled based at least on a Do format included in the PDCCH, wherein
a size of an HARQ-ACK codebook to be mapped to any of one or multiple second PUSCHs included in the one or multiple first PUSCHs is provided based at least on a UL DAI included in the DCI format,
the one or multiple second PUSCHs are provided based at least on some or all of a selection method 1, a selection method 2, a selection method 3, a selection method 4, a selection method 5, a selection method 6, a selection method 7, and a selection method 8,
the selection method 1 is a method for selecting a starting PUSCH,
the selection method 2 is a method for selecting a PUSCH immediately subsequent to the starting PUSCH,
the selection method 3 is a method for selecting a PUSCH with a preconfigured index,
the selection method 4 is a selection method for aperiodic
the selection method 5 is a method for selecting an ending PUSCH,
the selection method 6 is a method for selecting a PUSCH immediately preceding the ending PUSCH,
the selection method 7 is a method for selecting a PUSCH indicating transmission of the codebook,
the selection method 8 is a method for selecting multiple PUSCHs,
a method for indicating the selected PUSCH is any of an indication method 1, an indication method 2, an indication method 3, and an indication method 4,
the indication method 1 is a method for indication by the DCI format,
the indication method 2 is a method for indication by a MAC CE,
the indication method 3 is a method for indication by RRC signaling, and the indication method 4 is a method for indication for the aperiodic CSI.
